(19) United States
(12) Patent Application Publication
(10) Pub. No.: US 2009/0182588 A1
(43) Pub. Date: Jul. 16, 2009

(54) Market-level inventory control system and method

(75) Inventors: Roger J. Ashby, Edina, MN (US); Michael J. Lawrence, Eden Prairie, MN (US); Robert T. Wilson, Minneapolis, MN (US)

Correspondence Address: UNISYS CORPORATION, UNISYS WAY, MAIL STATION: E8-114, BLUE BELL, PA, 19424, US

(73) Assignee: Unisys Corporation

(21) Appl. No.: 11/313,105

(22) Filed: Dec. 20, 2005

(51) Int. Cl. G06Q 10/00; G06Q 50/00

(52) U.S. Cl. 705/5; 705/10

(57) ABSTRACT

A system and method for managing inventory on a market basis is disclosed. When employed by a transportation carrier, the system allows for the creation of a market group that includes a limited amount of space that is provided by any one or more of a certain group of physical routes (e.g., airline flights traveling between predetermined departure and destination points flying on selected dates). A qualifying customer or request may book one or more seats to this market group rather than to a specific physical route. The customer is guaranteed a seat on one of the physical routes, but is not informed as to the route on which travel will occur until a time closer to departure when the space allocated to the market group is mapped to the physical routes. In one embodiment, the market groups are defined using programmable business rules of a type interpreted by a rules engine.

### RELATED APPLICATIONS

The following commonly-assigned Patent Applications have some subject matter in common with the current Application, all of which were filed on even date herewith:

Ser. No. ______ entitled “Demand Tracking System and Method for a Transportation Carrier”, attorney docket number RA-5773;

Ser. No. ______ entitled “Rules-Driven Status and Notification System for a Transportation Carrier”, attorney docket number RA-5774;

Ser. No. ______ entitled “Allocation Limits System and Method for a Transportation Carrier”, attorney docket number RA-5775; and

Ser. No. ______ entitled “System and Method for Managing Customer-Based Availability for a Transportation Carrier”, attorney docket number RA-5777.

### FIELD OF THE INVENTION

The present invention relates generally to a reservation and departure control system for a transportation carrier; and, more specifically, to a system and method for supporting market-based inventory control on the sale of services.

### BACKGROUND OF THE INVENTION

Transportation carriers such as airlines, trains, cruise lines, bus companies and the like generally employ some type of reservation and departure control system (RDCS). Such systems are used to book passengers, track baggage, and manage departures and arrivals.

RDCSs have historically managed inventory at the physical level. For instance, a RDCS used by an airline maintains an inventory of available seats for each provided flight by flight number. Customers generally purchase seats on one of these flights by specifying a flight number, the desired number of seats, and the flight compartment (e.g., first class, coach, business class). If enough seats are available to accommodate this booking request, the seats are sold on the specified flight, and the inventory record for that flight is updated. This is accomplished by decrementing the number of available seats within the specified compartment for this flight by the number of seats purchased.

Recently, the type of sales model described above has been modified slightly to allow a customer to submit a request to be booked on a flight from a particular origin to a specified destination at a price that is generally highly discounted. In this type of scenario, the customer does not indicate the desired flight(s). In response to this request, a RDCS system searches for all available flights that may service that request, and if one or more flights have seats available to meet the request at the requested discounted price, the customer is booked on one or more of these flights. Only after this booking is completed does the customer receive a response indicating whether the request has been granted. Until the time this booking is completed, the customer is not guaranteed that a seat will be available at the discount price.

The type of discount system described above is similar to a conventional sales model. That is, inventory control is maintained at a flight level. A customer's discount request is matched against a flight-level inventory record to select one or more flights having seats available to satisfy the request. The customer is only guaranteed a seat after availability has been determined and the seats are sold on one or more flights. At that time, the customer is provided with a response indicating the flight number(s) of the one or more flights on which the customer has been booked. Until the customer is provided with those flight numbers, the customer's request is considered merely an offer that may, or may not be, accepted.

The type of prior art system that utilizes flight-level inventory management and control as discussed above often results in a non-optimal sales model. Consider, for example, a promotional deal that is offering “cheap seats” on flights from Minneapolis to Tampa Bay between the dates of March 1 through 7. The airline has allotted a predetermined number of seats that will be sold at discount prices for the flights from Minneapolis to Tampa Bay during this time period. Because inventory is managed at a flight level, the predetermined number of cheap seats must be allocated across the various flights from Minneapolis to Tampa before booking of these flights may begin. For instance, the airline may allocate these cheap seats evenly across all flights servicing the desired market. Alternatively, the airline may choose to allocate more of these seats to less popular flights that would typically not be full. In any event, these seats must be assigned to specific flights so that when one of the discount seats is purchased, the passenger can be booked to a flight. This is a non-optimal sales paradigm, since the discount seats may have been pre-assigned to a flight that could be filled to capacity without the use of promotions, decreasing the profit margin of the flight.

What is needed, therefore, is a more flexible inventory control system and method that addresses the foregoing, and other, limitations.

### SUMMARY OF THE INVENTION

The current invention provides an automated system and method to allow a transportation carrier or another service provider to manage inventory on a market basis. For instance, in the case of an airline, a market group may be created that includes a limited number of seats of a particular type (e.g., seats in booking class “Q”). These seats may be provided by any one or more of a certain group of flights, such as all flights traveling between requested departure and destination points during a designated time frame. A qualifying customer may book one or more seats to this market group, rather than to a designated flight, as will generally be done to get a discount fare.

At the time a seat is booked to a market group, a customer is guaranteed the space (e.g., five seats in coach on any one of the flights in the market group). However, the customer will not be informed as to the flight on which s/he will be traveling. This information is only obtained later when the space that was booked to the market group is mapped to specific flights. When this mapping occurs, generally some time close to the date of travel, the customer will be provided with flight and seat information.

The current invention allows discount seats to be mapped to flights some time after the bookings have been created in a manner that maximizes profits for the carrier. For instance, assume one of the flights that has seats that are included within the market group experiences an unexpectedly light demand such that many seats on the flight remain unsold close to the date of departure. Some or all of the discount seats may be mapped to that flight so that the other flights that have seats included within the market group, and that may have experienced a heavier demand, need not accommodate any of the market group seats.

The market groups of the current invention are created using one or more market group definitions. As an example, a market group may be defined as all seats on all flights from Minneapolis to Washington D.C. departing March 1 through March 7. It may be decided that for this market group, ten seats will be sold at a discounted price. As discussed above, these ten seats are allocated to the market group, but are not allocated to any particular flight. When a request is received to purchase one or more of these discounted seats, a record describing the market group is consulted to determine whether any of the seats allocated to the market group are available. If so, a record containing information about the market group that is retained within a market-based inventory is updated to reflect a sale of one or more seats, and the number of available seats in the market group is decremented in a corresponding manner.

As discussed above, when a market group is defined, a certain number of seats will be allocated to that market group (e.g., ten seats may be made available to those requests that are directed to the market group). This allocation may be considered either a limit or a reservation, as determined by the user-selected market group type. In the case of a limit-type market group, the market group definition indicates that at most, the allocated number of seats will be sold to the market group. In this scenario, if the airline receives a large number requests from customers that are willing to pay more than the market group discount price for a seat that is included within the market group, the airline may book fewer than the allocated number of seats to the market group. In this type of scenario, the airline need not book any seats to the market group.

In contrast to limit-type market groups, reservation-type market groups consider the allocated number of seats a reservation. In this case, the number of seats allocated to the market group must be guaranteed as being available for booking to that market group. This type of market group would generally be utilized when a third party such as a travel agency is pre-paying the airline to reserve the seats for the market group.

According to the current invention, both a market group inventory and a flight-based inventory are maintained. The flight-based inventory is used in a conventional manner to retain information about bookings that are made to specific flights. For instance, when a booking request is received to book seats on flight “X”, the flight-based inventory for flight X must be consulted to determine whether an adequate number of seats of the requested type are available to fulfill the request. In this case, the market-based inventory must also be consulted to determine whether any seats designated as available within the flight-based inventory for flight X are included within a market group. The market-group inventory may indicate that the seats which appear to be available according to the flight-based inventory are, in fact, unavailable because of bookings made to the market group. That is, even though the seats appear to be available in the flight-based inventory for flight “X”, these seats may have been sold to the market group such that completing the booking would cause the seats to be double-booked. In that case, the booking request to the specified flight cannot be completed.

As discussed above, market groups are created by a definition that indicates which flights and/or space within the flights are to be considered eligible to be booked to the market group. In one embodiment, these market groups are defined using programmable rules of the type interpreted by rules engines in a manner known in the art. Returning to the above example, a business rule may be defined to include within a market group all seats in all flights from Minneapolis to Washington D.C. during March 1 through March 7. If desired, this rule may be modified to further limit the market group by specifying certain times, compartments, and/or booking classes. For instance, the rule may be amended so that the market group includes only those seats in the coach compartment and only for those flights departing before noon on the weekdays within the specified date range. The market group may be narrowed still further by updating the rule to include only those seats in the coach compartment that are in the M or Q booking class. Any type of information that describes the space available on an aircraft may be referenced using programmable business rules.

In one embodiment, programmable reservation rules may be defined in addition to the market group rules. The reservation rules limit access to a market group. For instance, the market group may be open only to certain types of booking requests that originated from a predetermined web site, or from a predetermined location (e.g., a particular city, country, continent, etc.). Alternatively or additionally, customer profile data may be incorporated into the reservation rules. For instance, the market group seats may be reserved for only those customers that have somehow been previously inconvenienced by the airlines, as is recorded by customer profile data. As may be appreciated, virtually any type and combination of data describing bookings, space, and/or customer profile data may be used when defining market group and reservation rules.

In one embodiment of the invention, mapping rules may be defined to determine how space allocated to a market group will be mapped to physical flights. For instance, a rule may be defined indicating that a mapping will occur approximately equally across the three flights having the largest number of available seats, assuming enough seats are available in these three flights to accommodate this mapping. Thus, consider the foregoing example wherein the market group includes ten seats on flights from Minneapolis to Washington D.C. during March 1-March 7. According to the mapping rule, the three flights within groups of all flights included within this market group and having the greatest number of available seats will be selected to accommodate the market group seats. Thus, two of the selected flights will accommodate three seats, and the third flight will accommodate four of the market group seats. If desired, these mapping rules can be overridden by the booking information such that if five of the ten seats are booked to one party, all members of the party will be mapped to the same flight, if possible.

In one embodiment, the system and method also supports notification rules that determine when notifications will be issued to authorized airline personnel or customers regarding market group activity. For instance, a notification rule may be defined to cause a notification to be issued to passengers when the mapping of a market group to flights is completed. As an example, an email message may be automatically issued to each of the customers that had been booked to the market group indicating the flight to which they are now assigned following completion of the mapping. This email message may provide flight information such as a flight number, as well as a departure date and time, for instance. In the alternative, automated phone, fax, pager, or other communication transmissions may be generated to customers providing this type of information. Contact information (e.g., email addresses, phone numbers, etc.) may be obtained from customer profile data.

In addition to, or instead of, the types of communications discussed above, notification rules may indicate that communications are to be provided to authorized airline personnel to confirm that mapping has been completed. The airline personnel may then review the mapping information stored within the applicable market group record. This may provide information that is useful for demand forecasting, for instance.

According to one embodiment, an automated method of managing physical routes (e.g., specific flights) that are provided by a transportation carrier is disclosed. Such physical routes include airline flights, bus and train routes, and so on. The method includes defining one or more market groups, each including a selected amount of space to be accommodated on any one or more of the physical routes selected for inclusion in the market group. The method also includes booking at least some of the space to one or more customers of the transportation carrier, and after the booking step is completed, assigning the space that was booked to the one or more customers to any one or more physical routes selected for inclusion in the market group.

Another embodiment relates to an automated system for use by a transportation carrier. The system comprises a market group storage facility to store a market-based inventory describing space available within one or more market groups, each including selected space provided on selected physical routes of the transportation carrier. The system further includes booking logic communicatively coupled to the market group storage facility to sell at least part of the selected space on one of the market groups to customers without regard to which of the one or more physical routes will supply the space that was sold.

Also disclosed is a data processing system for use by a transportation carrier. The system includes means for defining market groups, each including selected space on selected routes provided by the transportation carrier. The system also includes booking means for booking passengers on at least part of the selected space without determining which of the selected routes the passengers will travel.

Yet another aspect relates to a computer-readable medium to cause a device to execute a method. The method includes maintaining a market-based inventory that describes one or more market groups, each market group including selected space on one or more selected routes provided by a transportation carrier. The method also includes selling to one or more customers at least a portion of the selected space included in one of the market groups without regard to which of the selected routes will provide the portion of the selected space.

Other scopes and aspects of the current invention will become apparent to those skilled in the art from the following description and the accompanying drawings.

### BRIEF DESCRIPTION OF THE DRAWINGS

FIG. 1 is a block diagram of one embodiment of a Reservation and Departure Control System according to the current invention.

FIG. 2 is a block diagram illustrating an exemplary embodiment of the Reservation and Departure Control System of FIG. 1 in further detail.

FIG. 3 is a block diagram of one embodiment of a system that maintains a market-based inventory to manage the sale of services.

FIG. 4 is a block diagram of one embodiment of inventory management logic according to the current invention.

FIG. 5A and 5B, when arranged as shown in FIG. 5, are a flow diagram of an exemplary method of defining a market group according to the invention.

FIG. 6 is a flow diagram of one method of handling booking requests that specify a market group according to one embodiment of the current invention.

FIGS. 7A and 7B, when arranged as shown in FIG. 7, are a flow diagram of one method of handling booking requests that specify a flight number according to one embodiment of the current invention.

FIG. 7C is a flow diagram of one method of mapping a market group to flights according to the current invention.

FIG. 8 is a screen diagram illustrating an exemplary screen such as may be used to define programmable market group rules.

### DETAILED DESCRIPTION OF THE DRAWINGS

For ease of reference, the following discussion is described primarily in relation to the airlines industry. However, it will be understood that this is merely for exemplary purposes. The system and method described herein may be adapted for use with any transportation provider, such as a bus company, a cruise line, a train service, and so on.

The system and method of the current invention provides a mechanism for managing inventory at the market level rather than on a flight basis. This allows bookings to be allocated to flights in a manner that optimizes profits. In one embodiment, programmable rules are used to control the market-level management of bookings.

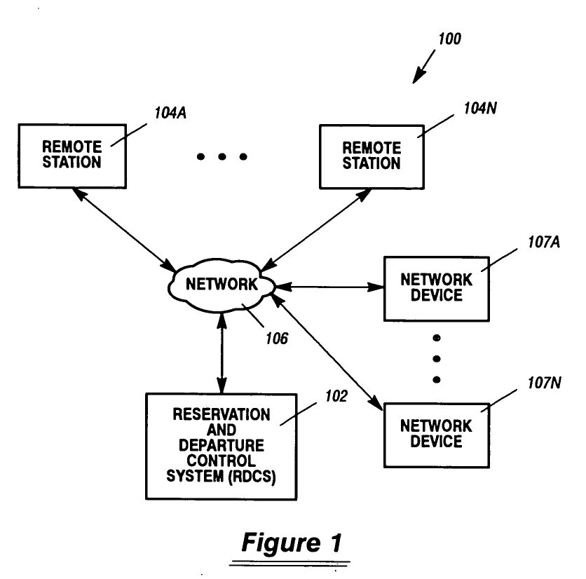

FIG. 1 is a block diagram illustrating an exemplary computing environment 100 that supports a Reservation Departure and Control System (RDCS) 102 that may usefully employ the current invention. RDCS 102 provides management and control services to a transportation carrier such as an airline. The services provided by RDCS may include, but are not limited to, request-handling capabilities, booking services, check-in functions, baggage-handling capabilities, and re-booking functions. According to the current invention, RDCS allows the sale of services (i.e., inventory control) to be managed at the market level, rather than on a flight-by-flight basis, as will be discussed below.

RDCS 100 may be coupled to a network 106. Network 106 represents one or more private or public networks such as the Internet or an intranet, and may include one or more Local Area Networks (LANs), Wide Area Network (WANs), wireless LANs and the like. Network 106 may also include one or more connected network-enabled computing and data-processing devices, such as personal computers, laptop computers, handheld computers, workstations, servers, routers, switches, printers, fax machines, telephones, or other devices. For ease of reference, these are represented by network devices 107A-107N. Such network devices execute communication software such as web browsers to communicate with RDCS 102.

Customers may utilize network devices to make requests for services to RDCS 102. For instance, a travel agent or a customer may utilize a personal computer to sign onto a web site that supports the electronic purchase of airline service. This user may then request information describing the availability of flights between a selected origin and destination within a particular time frame. Once this information is returned, the user may book one or more seats on an available flight. This will be discussed further below.

Also coupled to network 106 are remote stations 104A-104N that allow an authorized person to access RDCS using suitable communication software such as a web browser. Authorized personnel may include, for example, front-line staff, a system administrator, an inventory control agent, or other authorized users. Exemplary tasks include retrieving basic customer data, booking passengers on a flight, performing check-in activities, determining whether additional flights should be added to service a route to match demand, and generally accessing airline data and/or functionality supported by RDCS 102. Although remote stations 104 are typically remotely located from RDCS 102, it will be understood that this need not be the case.

According to the current invention, RDCS 104 may be used to manage inventory on a market basis. For instance, a passenger may be booked (i.e., guaranteed a seat) on any one of a group of flights traveling from Minneapolis to Washington D.C. during a particular time frame. According to this mechanism, although the customer is generally not informed as to the specific flight on which s/he will be traveling until close to the departure date, the customer is guaranteed to be traveling on one of the flights that is included in the group. Some time after the customer is booked to space included within the flight group, the airline may then allocate the space to whichever flight will result in maximum profits. For instance, one of the flights in the group may be largely empty such that a large portion of the discount seats may be allocated to that flight without disrupting sales of seats for other flights, thereby increasing the profit margin of the airlines. Before describing the market-level inventory control system and method further, a more detailed description of an exemplary RDCS 102 is provided for background information.

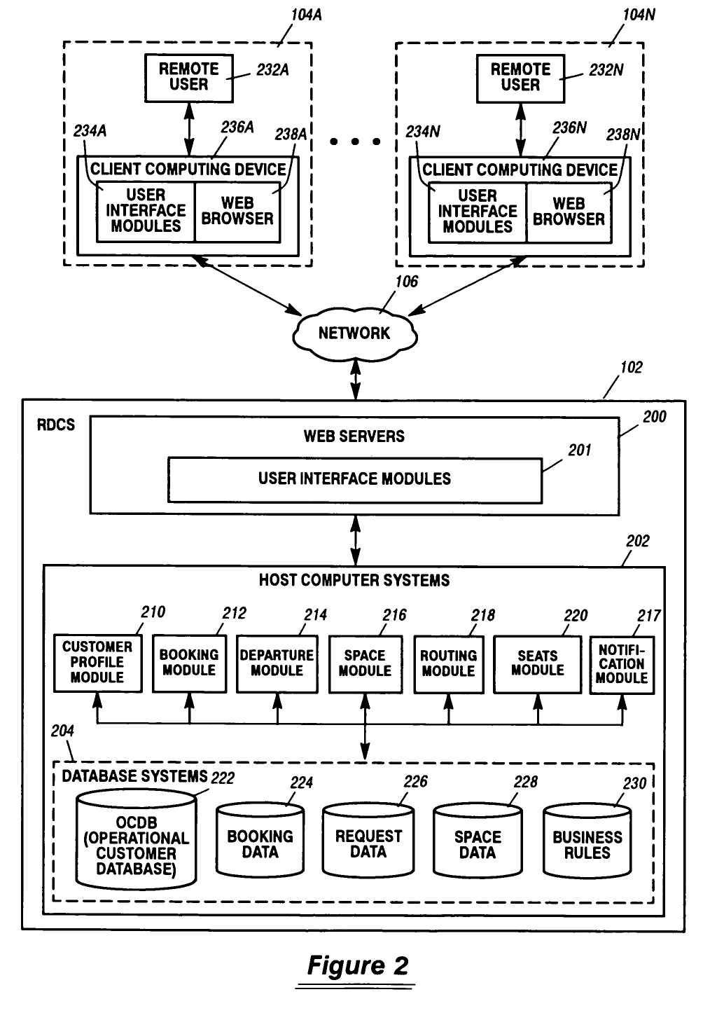

FIG. 2 is a block diagram illustrating an exemplary embodiment of RDCS 102 in further detail. In the exemplary embodiment, RDCS 102 includes one or more web servers 200 coupled to host computer systems 202. Host computer systems 202 may include one or more servers executing the Unix, Linux, Windows®, or any other operating system. Host computer systems 202 provide database systems 204 for storing data. Example database systems include SQL Server™ from Microsoft Corporation and the Oracle™ database from Oracle Corporation. Although illustrated separately, web servers 200 and host computer systems 202 may be integrated, and/or provided by one or more computing systems.

In general, RDCS 102 provides a computing platform for hosting management services for one or more airline carriers. In one embodiment, RDCS 102 provides network-based management of customer data stored in Operational Customer Database (OCDB) 222. OCDB 222 provides a centralized repository for maintaining consistent, current customer data for use by any of the service modules executed by host computer systems.

Host computer systems 202 execute software service modules 210-220. These service modules generally represent software modules having executable instructions to assist airline personnel in providing airline services. In this example, host computer systems 202 execute a customer profile module 210, a booking module 212, a departure module 214, a space module 216, a routing module 218, a seats module 220 and a notification module 217.

Customer profile module 210 allows a remote user to create, retrieve, and update OCDB 222. OCDB 222 is accessible by each of modules 210-220 and stores all information about a customer including preferences regarding seat assignments, meals, preferred connection points, hotel and vehicle preferences, and so on. OCDB 222 may also store contact information, travel plans, special customer needs and requirements, history information including any disservice the customer may have experienced in the past and any resulting compensation, frequent flier information, an assigned customer value that may be based on an amount of money the customer has spent on services provided by the carrier, a customer type (e.g., business versus leisure traveler) and any other information the airline desires to maintain. In addition, OCDB 222 includes primary customer data such as name, address, and payment information.

Customer profile module 210 may also populate OCDB 222 with links to biometric information maintained in an external database. In some embodiments, OCDB 222 may be embodied by, or coupled to, a Customer Loyalty System (CLS) commercially available from Unisys Corporation that handles processing of frequent flier information.

Turning next to booking module 212, this module receives and manages the booking data associated with airline flights. Booking data is defined as all of the information about a passenger or a group of passengers that are traveling together on the same journey. Such information, sometimes referred to simply as “a booking”, includes passenger names, which one or more flights are included within the journey, and any special requirements such as special meals, wheelchairs, etc. that may be needed by one or more members in the party. It may further include car rental and hotel information, the manner in which the passengers are being ticketed, data regarding travel documents, contact and payment information, and information regarding any other accommodation or service associated with the journey. This data is stored as booking data 224 within database systems 204.

Departure module 214 manages the check-in process on the day of departure, including the check-in of passengers and baggage. For example, an airline employee, shown as one of remote users 232A-232N, may interact with departure module 214 to obtain the issuance of boarding passes and bag tags, and to manage standby passengers. In addition, a remote user may indicate any special needs and requests required by passengers as identified during the check-in process.

Space module 216 manages information regarding the space that is available on flights provided by the current carrier. For instance, this module controls sales restrictions for flights. This module may be coupled to an external space module (not shown), which provides information on space available on flights provided by other carriers. Another related module, seats module 220, provides information on the layout of each aircraft, including information concerning the seating configurations.

A flight module (not shown in FIG. 2) may be provided to define the flights that are hosted by the airline. For example, this module may determine departure and arrival flight times and locations, the aircraft assigned to a given flight segment, information on fare classes, and information regarding the class of services provided by a flight. This information may include data describing flights provided by the selected airline carrier, as well as flights provided by airline carriers that are considered partners of the selected carrier according to various partnership agreements between two different carriers.

The data created and managed by flight module is available to routing module 218. Routing module 218 utilizes this data to determine the various route options that are available to customers. For example, routing module will determine the best way for a customer to travel from a desired departure location to a destination point using the flights generated by flight module.

Finally, notification module 217 provides automated notification functions that are programmable based on any of the data stored as booking data 224, request data 226, and/or space data 228. In one embodiment of the current invention, notification module 217 may be programmed to provide automated notifications regarding a booking that has been allocated to a flight after a market group has been mapped to flights. For instance, an email notification may be issued to the passengers were initially booked to a market group to provide the flight information (e.g., flight number, departure time and date) for a previously-purchased seat. Notification module 217 might similarly be programmed to automatically generate phone calls, provide faxes, issue pages, and so on. The contact information for these types of communications may be obtained from customer profile data maintained within ODCB 210. This is discussed in detail below.

Host computer systems 202 may include other service modules (not shown) that are coupled to OCDB 222, including a ticketing module for managing ticketing activity, an information module for managing automated information such as visa requirements, ticketing rules, luggage policies and procedures, fare rules, promotions and the like, an agreement module to store agreements that exist between an airline and its partners, and a load control module for assisting airline load control agents in planning the distribution of payload aboard an aircraft.

Web servers 200 provide a seamless interface by which remote users 232A-232N or local users (not shown) may access host computer systems 202. Although host computer systems 202 and web servers 200 are illustrated separately in FIG. 2 for exemplary purposes, RDCS 102 may be realized by a single computing device or a plurality of cooperating computing devices such as a clustered computing architecture.

According to the exemplary embodiment of FIG. 2, web servers 200 provide a web-based interface by which authorized remote users 232A-232N communicate with RDCS 102 via network 106. In one configuration, web servers 200 execute web server software, such as software marketed by Microsoft Corporation under the trade designation “INTERNET INFORMATION SERVER.” As such, web servers 200 provide an environment for executing user interface modules 201. User interface modules 201 provide an interface that allows users 232A-232N to manage airline reservations, check-in, and re-booking functions. User interface modules 201 may include Active Server Pages, web pages written in hypertext markup language (HTML) or dynamic HTML, Active X modules, Java scripts, Java Applets, Distributed Component Object Modules (DCOM), and the like.

User interface modules 201 may execute within an operating environment provided by web servers 200. Alternatively, portions of user interface modules 201 may be downloaded as “client-side” user interface modules 234A-234N that are executed on client computing devices 236A-236N, respectively. Client-side user interface modules 234A-234N could, for example, include Active X components or Java scripts executed by web browsers 238A-238N running on client computing devices 236A-236N, respectively.

It will be understood that the RDCS shown in FIG. 2 is exemplary only. Other systems may include fewer or more modules, may omit or add functionality, and/or may implement similar functionality in alternative ways. Thus, FIG. 2 should be considered as only one of many types of systems that may usefully employ the current invention.

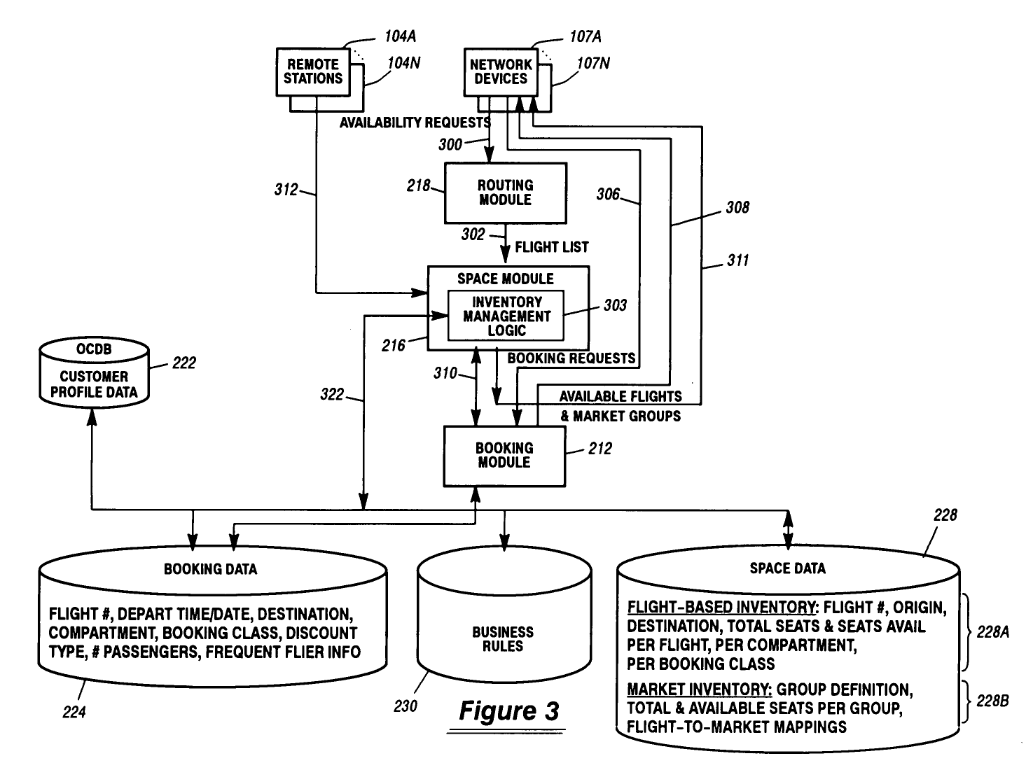

FIG. 3 is a block diagram of one embodiment of a system that maintains a market-based inventory to allocate the sale of services. Before discussing the market-based inventory system and method of the current invention in detail, a general overview is provided regarding an exemplary method of handling availability requests and booking requests within a RDCS. Merely for discussion purposes, this method of handling requests is described in terms of the modules existing within illustrative RDCS 102 of FIG. 2. However, as previously mentioned, many different types of alternative RDCS systems exist that may provide similar or different functions, have more or fewer modules, and that may handle booking and availability requests in a different manner. Thus, it will be understood that the method of handling availability and booking requests as described in the following paragraphs is only one of very many alternative methods, and is provided solely for background purposes, and to facilitate a better understanding of the description of the invention that follows. For ease of reference, only those requests submitted by network devices 107 will be discussed, however it will be understood that this discussion applies equally to any availability requests received by RDCS 102, including those submitted via remote stations 104, which may include those requests issued by booking agents of the airline.

Availability requests are shown being received from users of network devices 107A-107N. Such requests are issued to make inquiries pertaining to the availability of one or more flights.

Availability requests may be received from a wide array of sources. For instance, such requests may originate from an on-line travel agency such as the Obitz.com web site. These requests may also be submitted via a global distribution system (GDS) of the type used by travel agencies to determine availability of flights. Such GDSes include Saber, Worldspan, Amadeus, and so on. In yet another embodiment, the requests may originate from another RDCS that is hosting a different airline. In one embodiment, availability requests are not only submitted via network devices 107, but are also issued by users at remote stations 104 who may be employed as booking agents.

Availability requests generally include such information as a desired departure time, date, and origin, as well as the flight destination location. The requests will generally also specify a desired airplane compartment, such as a first-class, business-class, or coach compartment.

Availability requests received from outside of the RDCS 102 (that is, from other than a booking agent located at remote stations 104) will also generally include a flight number. That flight number is obtained from local flight information stored by the entity that issued the request. For instance, a travel agency or an on-line travel web site may locally store information describing the flights provided by one or more airlines. This information may become outdated over time, and thus an availability request may be issued by the travel agency or web site to RDCS 102 to determine whether one or more specified flights are still available.

Availability requests may also include customer information such as a name, a frequent-flier number, and/or other customer identification. Other information that may be received by RDCS 102 along with the request includes the origin of the request, such as a location (e.g., city, country, continent), and/or the name of the web site from which the request was issued. The type of origin information that is provided with the request will generally vary depending on whether the request was issued via a GDS, Internet, from a request issued by a booking agent of the airline, and so on.

The request information may also specify whether the request is being issued by schedule or price. In other words, the request will indicate whether the requested departure time is more important than seat price, or vice versa, as determined by information provided by the customer.

As may be appreciated from the foregoing, many different types of information may be provided with an availability request. Such information may include, but is not limited to, the source of the request (e.g., web site, travel agent, etc.), the time and/or date on which the request was issued, the type of request (whether it was issued by price or schedule), the origin and destination of travel, requested time and date of travel, one or more flight numbers (as provided with those requests that originate from sources other than the airline's booking agents, for instance). Other information provided with availability requests may include a compartment name, and customer information (name, frequent flier information, customer identification numbers, etc.).

The availability requests are providing to routing module 218 on line 300. Routing module 218 will select one or more of the existing routes (in this example, flights) that may potentially satisfy the customer's request. These routes will generally be selected based on the origin and destination of the requested travel, as well as the requested departure time. The most preferential routes will generally be those that contain a single flight that directly services the requested origin and destination locations, and that departs the closest to the requested departure time. Other routes may include multiple flights or flight segments such that a customer traveling on the route may have to change planes and/or experience a delay at an intermediate stopping point. The number of possible options retrieved by routing module 218 for a given request may be a programmable operating parameter of the system that is selected by an authorized airline employee.

After routing module 218 determines a list of flights that may potentially satisfy the customer's request, fare information is retrieved for these routes. This information may be obtained by making a request to a fare module (not shown), for instance.

Next, this list of flight options, the fare information, and information regarding the availability request are provided by routing module 218 on line 302 to space module 216. Space module then determines which flights and/or flight combinations are considered available, meaning the flights include enough seats to satisfy the availability request. This may further involve determining whether available seats reside within the particular compartment specified by the request.

Prior art systems make the type of space determinations discussed above solely based on a flight-based inventory 228A within space data 228. That is, space module utilizes data that is stored on a flight-by-flight basis to determine whether a potential flight, compartment of a flight, and/or booking class of a flight are available to satisfy an availability request. The system searches the data for each flight to identify the candidate flights that may be returned to the requester in response to the availability request.

After space module 216 determines which flight options have seats available to satisfy the availability request, space module returns a list of M of these available flights on interface 311 to the original requester at one of network devices 107. This list includes flight departure times, dates and fare information. In one embodiment, the number of flights M included in this list may be a selectable parameter determined by a system administrator.

The process of submitting an availability request and receiving the results may be repeated any number of times. If the customer finally determines that one of the returned flight or flight combinations will satisfy his/her requirements, a booking request may be submitted on line 306 to booking module 212 to actually purchase one or more seats. This booking request will generally specify a particular flight or flight combination by one or more flight numbers.

In general, a booking request also includes the price of a seat. This price maps to a booking class. As is known in the art, booking classes are used to control availability of seats at predetermined prices. For instance, a promotional deal may be offered whereby a limited number of seats are being sold at a deeply discounted price. To control the number of seats sold at this price, these seats are mapped to a booking class. The booking class is then generally associated with a compartment (e.g., first class, coach, etc.) and the number of seats available at the discount price.

An airline may define many booking classes for the same compartment. For instance, the coach compartment of an aircraft may be divided into booking classes such as “Q”, “B”, and “M” classes.

As may be appreciated by the foregoing, since a booking request will generally include pricing information, and since pricing information maps to a booking class which, in turn, is associated with a compartment, a booking request is associated with both a booking class and compartment. This booking request will also usually include customer information such as passenger names and any frequent flier information. A booking request may further include other identifying indicia such as address, phone, and other customer contact data, as well as whether the booking request is associated with any special needs (e.g., wheel chair request, unaccompanied minor, and so on.)

When booking module 212 receives the booking request, a determination is made as to whether the requested seats on the requested flight(s) are available for purchase. In one embodiment, booking module makes this determination by submitting a request to space module 216 via interface 310. Space module 216 responds by indicating whether space is available such that the request may be completed. If space is available, booking module ensures that the purchased number of seats is reserved for the given request, although the actual seat assignment will generally not occur at this time. Space module 216 then increments the number of seats sold in the appropriate compartment of the flight by the purchased number of seats, effectively decrementing the number of available seats for the compartment.

After the seats have been reserved, booking module 212 returns a response to the customer on line 308 indicating that the booking was completed successfully. Booking module 212 then stores information describing this booking to booking data 224. The stored information includes data concerning the passengers for this booking, including passenger names, addresses, any seating preferences or assignments, frequent flier information, payment information, and so on.

As noted above, space data 216 contains information pertaining to the availability of seats on flights. In prior art systems, this type of data is maintained solely on a flight-by-flight basis using a flight-based inventory 228A, as shown in FIG. 3. This data may indicate total flight capacity, the compartment and booking class to which each seat in the flight is assigned, and the seats that are still available on a given flight for each flight offered by the airline. Thus, this information reflects the available seats per compartment and booking class on a flight-by-flight basis. This information may further include other information such as a description of each flight (e.g., flight time, origin, and destination).

As discussed above, when seats are booked by booking module 212, space module 216 must update space data 228 so that the booked seats are no longer recorded as being available. In prior art systems, this solely involves updating the flight entry within flight-based inventory 228A.

The foregoing discussion describes the situation wherein the booking request that is submitted for processing to booking module 212 on line 306 specifies a flight number. For instance, the request will indicate a desire to purchase two seats on flight XYZ. According to a different type of request, a potential customer may omit the flight number when submitting a booking request via interface 306. In this alternative scenario, a booking request may include a price (generally, a discount price), an origin and destination, and an approximate time of travel. In this case, the customer is willing to forego specifying the flight and exact time of travel in exchange for obtaining the discount price for the seat.

In a prior art system, a booking request that does not specify a flight will be provided to space module 216 so that space module can search flight-based inventory 228A to determine if any seat is available on a flight that meets the booking request criteria. If such a seat and flight exists, the customer is booked on that flight. Only after the booking to this flight is completed will the customer be notified that a seat has been guaranteed. That is, in prior art systems employing a flight-based inventory 228A, the customer must be assigned to a flight before space can be booked to that customer.

The type of prior art system that utilizes flight-based inventory management and control as discussed above often results in a non-optimal sales model. Consider, for example, a promotional deal that is offering “cheap seats” on flights from Minneapolis to Tampa Bay between the dates of March 1 through 7. Assume that the airline has allotted a predetermined number of seats that will be sold at discount prices for the flights from Minneapolis to Tampa Bay during this time period. Because inventory is managed at the flight level, the predetermined number of cheap seats must be assigned to various flights that are flying from Minneapolis to Tampa Bay during these dates before a passenger can be booked to one of these discount seats. When a request for one of these seats is received, a search of the flight-based inventory 228A is then conducted to locate a flight that contains enough available discount seats to accommodate the request. If such a flight is located, the customer is booked to this flight and the flight-based inventory is updated to indicate that these seats are no longer available.

The above-described mechanism involves a non-optimal sales paradigm because the allocation of the discount seats to flights must be completed before the demand for the flights can be definitively determined. This requirement exists because the inventory is maintained on a flight-by-flight basis. According to this prior art system, if a strong demand is anticipated for a flight, it is likely that no discount seats will be allocated to that flight, since it is believed that the seats will likely be sold without the use of this promotion. If this anticipated demand does not materialize, the flight may fly at less-than-full capacity such that the airline forfeits revenue. Conversely, in the prior art system, a flight that was not anticipated to have strong demand is likely to be allocated at least some of the discount seats. If this flight unexpectedly draws a higher demand, a higher profit margin may have been achieved if the discount seats had not been allocated to this flight in this manner. In either case, it may be appreciated that the prior art method that is based solely on the use of a flight-based inventory does not result in an optimal sales model that maximizes profits.

To address the foregoing limitations, the current invention supports space data 228 that includes not only a flight-based inventory 228A, but also a market inventory 228B, as shown in FIG. 3. The management and reconciliation of these two inventories is maintained by inventory management logic 303, which is shown included in space module 216 of the present invention.

Market inventory 228B of the current invention includes one or more market group definitions (“group definitions”). As an example, a market group may be defined as including all seats on all flights from Minneapolis to Washington D.C. that are departing March 1 through March 7. It may be decided that for this market group, ten seats will be sold at a discounted rate. At the time of a sale of one of these discount seats, it is not known which flight will accommodate the seat. Only later will the sold seat actually be mapped to a flight so that the customer can be informed on which flight s/he will be traveling. The handling of a booking request using the above-described mechanism occurs as follows. When booking module 212 receives a booking request to purchase one of the discounted seats in the market group, booking module 212 communicates this request via interface 310 to space module 216. Space module then retrieves data for the appropriate market group that is stored within market inventory 228B to determine whether any of these discount seats are still available. If so, the market inventory is adjusted to reflect a sale of the seat, and booking module 212 is informed that the booking may be completed.

When space module 216 updates the market inventory to reflect a sale of a seat, the seat is not assigned to a particular flight. Rather, the seat remains assigned only to the market group of all flights from Minneapolis to Washington D.C. during March 1 through March 7. After booking module 212 completes the booking, the customer is notified that the booking is finalized, and a seat has been guaranteed for that market group, but the customer is not informed as to the flight that will accommodate the booking.

As discussed above, some time after bookings have been made to the market group, the seats allocated to a market group are mapped to flights. This will generally occur at a time close to the departure time and date of the first departing flight that is included in the market group. Thus, in the current example, this may occur as little as a few days prior to March 1. At this time, the demand for each flight in the market group has been established. Thus, the mapping can occur in a manner that most optimally fills the flights. As an example, the discount seats may be mapped to one of the flights of the market group that unexpectedly experienced a very light demand. This flight likely has seats that would otherwise be empty, and that can therefore be used to accommodate the discount seats such that profits for the flight are maximized.

Returning to a discussion of the system of FIG. 3, market-based inventory 228B maintains a record for each defined market group. That record may store the group definition, which in the current example includes all seats on all flights from Minneapolis to Washington D.C. between March 1 and March 7. This record may further store the number of seats “allocated” to (that is, for sale within) the market group. For example, in the foregoing illustration, ten seats have been allocated to the market group. There are several ways in which this seat allocation may be handled, as will be discussed further below.

Market-based inventory 228B may further store information regarding the total seats that have been booked thus far to the group, as well as how many seats may yet be booked for the group. In one embodiment of the invention, the market group record further tracks the “total eligible seat count”, which is the number of all seats that are available to potentially accommodate the seats that have been allocated to the market group. Assume, for instance, that in the current example, one flight per day flies from Minneapolis to Washington D.C., and that each such flight has a total of 100 seats. Thus, a total of 700 seats are available on all seven flights from Minneapolis to Washington D.C. from March 1 through March 7. Therefore, prior to the time any of these seats have been booked, the total eligible seat count that is available to satisfy the seats that have been allocated to the market group is “700”.

This total eligible seat count must be decremented each time a conventional-type booking is made to a seat included in the market group, since the booked seat(s) are no longer eligible to accommodate the seats that have been allocated to the market group. For instance, assume a booking request is received to book two seats on the specific flight “XYZ” that is traveling on March 1 from Minneapolis to Washington D.C. When this booking is completed, the total eligible seat count for the associated market group must be decremented by “two”, since these two seats are no longer available to accommodate the discount seats allocated to the market group.

In a similar manner, the total eligible seat count is decremented when bookings are actually created to the market group, and not to a particular flight. This is because when one or more seats have been sold to the market group, these seats are no longer available to accommodate any other booking to the market group.

Additionally, the total eligible seat count must be adjusted when bookings involving seats in the market group are cancelled. Specifically, when a booking that was made to a particular flight is cancelled, and the formerly booked seats are included within a market group, the total eligible seat count for that market group is incremented by the number of cancelled seats, since these seats are now available for use in fulfilling the seats allocated to the market group. Likewise, any time flights in the market group are cancelled, or flights are added that are included within the market group definition, the total eligible seat count must be adjusted accordingly.

As can be appreciated by the above discussion, the term “seats” is used when describing market groups. For instance, seats are said to be included within a market group. These are the seats that are eligible to fulfill requests directed to the market group. Seats are also said to be allocated to a market group. These are the seats that may be sold at the discount price associated with the market group. In either case, the term “seat” is referring to space generally, and not to any specific seat at any particular location within any identified aircraft. That is, “seat” merely refers to some space that can accommodate one passenger, without regard to where that space is actually located within a group of one or more flights.

As noted above, a predetermined number of seats are said to be allocated to a market group. For instance, in the foregoing example, ten seats were allocated to the market group, indicating that these ten seats are available to be sold at a discount price. This allocation may be handled in one of several ways depending on the reason for creating the market group. In one embodiment, a market group is created for an entity such as a travel agency that is requesting a guarantee that ten seats will be provided at the discount price. The travel agency will generally pay a price for this guarantee. In this case, the allocated ten seats must be reserved for the market group such that they are guaranteed to be available to that market group. The airline must ensure that enough seats are saved to meet this guarantee. These types of market groups may be referred to as “reservation-type” market groups.

Reservation-type market groups are used to satisfy booking requests in the following way. Assume that a booking request is received that requests two seats on flight “XYZ”. Because a flight number is indicated, this request may be booked in a conventional manner using the flight-based inventory. It will be assumed that when the flight-based inventory is consulted to determine the number of seats on flight “XYZ”, five seats are indicated as being available to fulfill the request. Assume further that these available seats are included in the market group illustrated above, which has been defined as a reservation-type market group.

Because the seats involved with the current request are included in the market group definition, the record for this market group must be consulted to determine whether the request may be fulfilled and the booking completed. Assume that the market group record indicates that five of the ten seats allocated to this market group remain to be sold. Further assume that only five of the 700 seats included in the market group definition (that is, the five seats on flight “XYZ”) are not yet booked. In other words, the total eligible seat count for the market group has been decremented to “five”. In this scenario, none of the five remaining seats on the flights in the market group may be booked to satisfy any conventional booking request, since all of the remaining five seats must be reserved for the market group, which is a reservation-type market group.

To summarize the foregoing, when a conventional type booking request is received, it must be determined whether the requested seat(s) are included within a reservation-type market group. If so, that booking request cannot be honored if fulfilling that request will cause the total number of eligible seats available to fulfill market group requests to drop below the number of seats that remain to be sold for that market group. This is true even if the flight-based inventory indicates that enough seats remain on the requested flight to fulfill the request.

The foregoing relates to the way reservation-type market groups are used to fulfill a booking request. In another type of situation, the airline creates a market group for its own purposes, rather than on behalf of a paying third party such as a travel agency. The airline may create the market group for promotional reasons, for instance. The airline is therefore not guaranteeing any third party availability to the seats allocated to the market group. Thus, the number of seats allocated to a market group may be considered a limit, and not a reservation. That is, the market group is a “limit-type” market group.

Use of limit-type market groups occurs as follows. Assume that the market group of the foregoing example is a “limit-type” market group rather than a reservation-type market group. In this case, no more than ten seats may be sold to the market group, but fewer such seats may be sold if other higher paying customers are submitting requests to book these seats to specific flights. That is, if conventional booking requests that specify a flight are received, the requests may be satisfied even though this means the total eligible seat count for the market group will fall below the number of seats that remain to be sold in the market group.

Returning to the foregoing example, assume that five of the ten seats allocated to the market group remain to be sold. Further, only five of the 700 seats on all of the seven flights included in the market group definition are not yet booked. This is indicated by the total eligible seat count for the market group, which is set to “five”. These five available seats happen to be located on flight “XYZ”.

Next, assume a conventional booking request is received that requests five seats on flight “XYZ”. The flight-based inventory for the requested flight indicates that at least five seats are available to satisfy the request. After consulting the market group record, it is determined that satisfying the request will cause the total eligible seat count for the market group to be decremented from five to zero such that no further seats are available to be booked to the market group. This is considered acceptable even though five seats remain to be sold to the market group. In this case, since the market group is of the limits type, the conventional request may be fulfilled. The customers submitting this request will almost certainly be paying more for these seats than if they had submitted a request directed to the market group.

Before continuing, it is important to note that when processing a conventional booking request for seats that are included within a limit-type market group, although the seats remaining to be sold in the market group need not be considered, the number of seats already sold to that market group must be taken into account. For example, in the current scenario, the total eligible seat count for the market group is originally set to “five”, indicating that only five of the 700 seats in the market group are still available to satisfy requests to the market group, and 695 seats have been sold. The 695 seats sold reflect the five seats that were sold to the market group, but that have not yet been allocated to a flight. Since they remain unallocated to a flight, it is possible that a flight-based inventory for one of the flights in the market group (for example, flight “XYZ”) indicates that the flight has as many as ten available seats remaining. This is because the flight-based inventory is not yet taking into account the five seats that have been sold to the market group, and thus is indicating as available all five seats sold to the market group, as well as the five seats that are actually still available.

Next, assume that a booking request is received that requests six seats on flight “XYZ” included in the market group definition. The flights-based inventory for this flight indicates ten seats remain available for the reasons set forth above. However, in actuality, only five seats are available on this flight, since the other five seats have been sold to the market group but are not yet allocated to the flight. Thus, if this request is satisfied, one seat will be double-booked. That is, the seat will be booked both to the conventional request and to a previously-received request that was directed to the market group. To prevent this type of situation, when a conventional booking request that specifies a flight number is received for seats that are included within a limit-type market group, the total eligible seat count for the market group cannot be allowed to be decremented below zero. That is, the number of seats that may be booked to the conventional request cannot exceed the total eligible seat count for the market group, which in the current example is “five”. This ensures that seats are not double-booked.

A market group type is generally selected for a market group when it is created. The record for the market group will identify whether that market group is of a reservation-type or limit-type. Further examples are provided below to exemplify the manner in which limit-type and reservation-type market groups are handled.

As discussed above, market groups are created by a definition that indicates which flights and/or seats within the flights are to be included in the market group. In one embodiment, these market groups are defined using programmable rules that are stored as programmable business rules 230. For instance, in the above example, the rule indicates that all seats in all flights from Minneapolis to Washington D.C. during March 1 through March 7 will be included in the market group. This rule may be modified to further limit the market group by specifying certain times, compartments, and/or booking classes. For instance, the rule may be amended so that the market group includes only those seats in the coach compartment, and only for those flights departing before noon on the weekdays within the specified date range. The market group may be narrowed still further by updating the rule to include only those seats in the coach compartment that are in the M or Q booking class. In this manner, any type of information included as space data may be used to define the market groups using programmable business rules. This is discussed further below.

In yet another embodiment, information pertaining to the actual request may be included in the market group definition. For instance, the market group may be open only to those requests originating from a predetermined web site, or from a predetermined location (e.g., a particular city, country, continent, etc.). This information may be stored with the space data 228 or instead with booking data 224. Optionally, customer profile data of the type stored within OCDB 222 may be incorporated into the market group definitions. For instance, a market group definition may be limited to only those customers that have somehow been previously inconvenienced by the airlines, as is recorded within their customer profile. As may be appreciated, virtually any type and combination of booking, space, and customer profile data may be used when defining market groups.

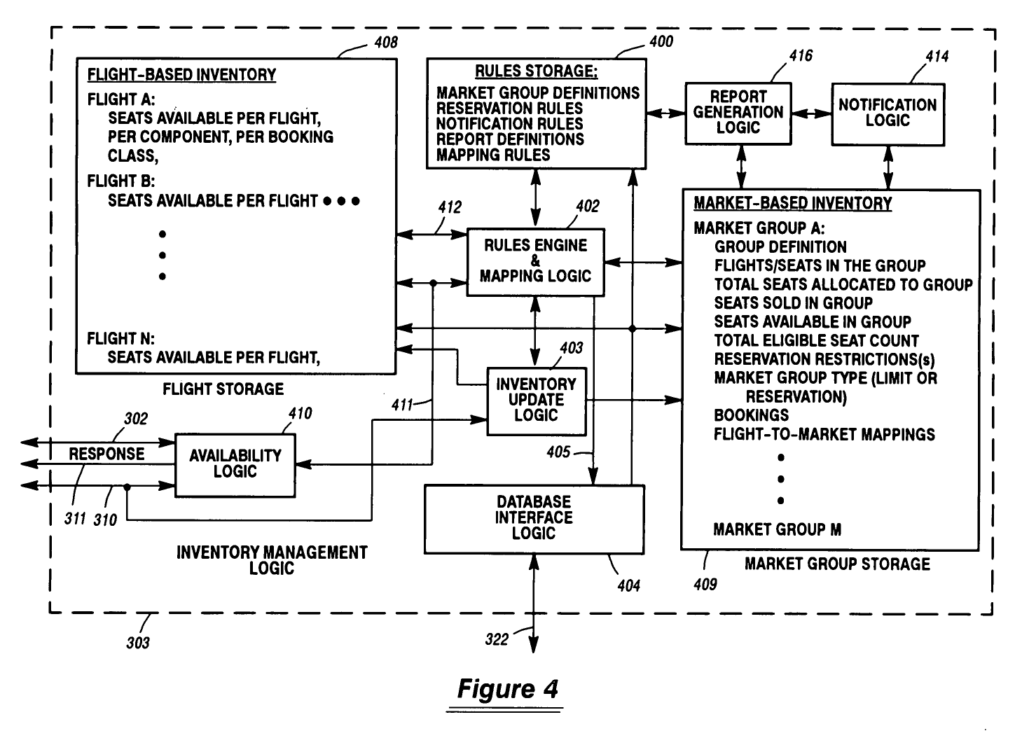

FIG. 4 is a block diagram of one embodiment of inventory management logic 303 according to the current invention. In a preferred embodiment, this logic is incorporated into space module 216, although it will be understood that the logic could be partitioned in many other ways.

Space module 216 includes rules storage 400 for storing the definitions for the market groups. As discussed above, these definitions are created using programmable rules, as will be discussed further below. In one embodiment, these rules are retrieved from business rules 230 of database systems 204 via interface 322 and retained within rules storage 400 so that they are readily available for processing by inventory management logic 303. In one embodiment, rules storage 400 may be a main or cache memory area that is allocated to inventory management logic 303 but that physically resides elsewhere.

The market group definitions stored within rules storage 400 describe the market groups that will be created to manage the sale of seats at other than the physical (e.g., flight) level. Such definitions may take into account any of the attributes or data associated with space data 228. For instance, the definitions may specify one or more flight origins and destinations. These origins and destinations may be one or more cities, countries, continents, airports, and so on, that are tracked by space data or some other data stored within database systems 204. The definitions may further specify dates, times, compartments, and booking classes available from booking data 224. According to one aspect, the rules may specify a list of flights (e.g., by flight number) that are to be included in the market group. When booking requests are received that are directed to the market group instead of a particular flight, the requested seats are booked to the market group, and not to the flight as would occur in conventional booking systems.

Other information may be used to define other types of rules associated with the market groups. For instance, in some cases, information about how the booking request was submitted may be provided by booking module 212 to space module 216. This information may include the time of request submission, as well as how the request originated (e.g., was issued from website “X”, was submitted by travel agency “Y”, or was provided to the airline's booking office “Z”). This information may be included in “reservation” rules that determine whether a request is eligible to create a booking against the market group.

In one embodiment, reservation rules may take into account customer data such as frequent flier information, whether the customer was previously inconvenienced by the airline, and/or whether the customer is considered to be of “high value” by the airlines. This type of customer information may be stored within OCDB 222 or some other place within database systems 204. This data may be used to determine whether a customer is considered eligible to book seats to the market group. This will be discussed further below.

Other types of rules may be defined for use within the system. For instance, enabling and disabling rules may be defined to enable and disable, respectively, the use of associated market group definitions, as will be discussed below. Additionally, notification rules may be defined for use in automatically generating notifications to customers when the market groups are mapped to the flight inventory, or when other events associated with the market groups occur. Further, report definitions may be stored within rules storage 400. These definitions describe reports that contain information pertaining to one or more market groups. Such reports may be automatically generated at predetermined times or based upon the occurrence of selected trigger events. The various types of rules mentioned above will be discussed in detail below.

Rules storage 400 is accessible to rules engine and mapping logic 402 (hereinafter, “rules engine”), which is the logic that is capable of interpreting the various market group definitions. This rules engine may be a business rules engine of the type known in the art. Many such business rules engines are commercially available for this purpose. One example is the JRules rules engine commercially available from Ilog Incorporated. In yet another embodiment, rules engine 402 may be replaced by table-driven logic, as is discussed further below.

Rules engine 402 is coupled to database interface logic 404 via interface 405. Database interface logic 404 is capable of searching space data 228, booking data 224, OCDB 222, and any other applicable data stored within database systems 204 to retrieve information to determine which flights and/or seats are to be included within a market group. This searching is initiated via interface 322.

In one embodiment, searching of database systems 204 for some, or all, of the data may not be needed if that data is provided directly by another module. For instance, booking module 212 may provide booking data directly to inventory management logic 303 via interface 310. As discussed above, booking module 212 may provide this booking information to space module 216 as the booking is being created. This allows space module to update its inventory records without searching booking data 224 via interface 322. This is discussed further below.

Inventory management logic 303 may further includes flight storage 408, which is local storage space that is allocated to space module 216. This flight storage space 408 stores a flight-based inventory of the flights provided by the airline, as discussed above. Thus, for instance, this flight-based inventory may include a record for all, or a sub-set of all, flights provided by the airline. Each record includes the flight number, the total capacity of the flight, and the total capacity of each compartment and booking class for the flight. This record also contains the total number of seats available on the flight, as well as total seats per compartment and booking class for the flight. It may be appreciated that this information is also contained as flight-based inventory 228A of space data 228 (FIG. 3), which resides within database systems 204. However, better performance may be obtained by caching some or all of this data in local flight storage 408, as shown.

Inventory management logic 303 may further include market group storage 409. This is local storage space that is allocated to space module 216. Market group storage 409 retains all, or a portion of all, of the market-based inventory 228B that is described above. This market-based inventory stores a record for each market group that has been defined via a definition stored within rules storage 400. Each such record may contain the market group definition, as well as a description of the flights and/or seats that are included within this market group. The record also includes the total number of such seats included within the market group, also referred to as the total eligible seat count, as discussed above. The record may further include the total seats that have been allocated to the group.

A market group record may further include the seats that have been sold thus far within the group, as well as the seats that yet remain to be sold in the group. These counts are maintained as follows. Returning to the foregoing example wherein ten seats are allocated to the market group, assume that a first request that is directed to the market group results in the purchase of two seats. The “seats sold in the market group” is therefore set to “two”, and the “seats available within the market group” is decremented from “ten” (the original number allocated to this group) to “eight”. Additionally, the total eligible seat count is decremented from the original number of “700” to “698”. (This assumes that no customers have yet been booked to any of the flights included in the market group.)

Next, assume that a conventional booking request is received that specifies flight “XYZ” instead of the market group. The request results in the sale of ten seats, all of which are included within the market group. To record this sale, the flight-based inventory for this flight is updated to increment the seats purchased for this flight, generally by compartment and booking class. This sale must also be recorded within the market group record. This occurs by decrementing the total eligible seat count for the market group from “698” to 688, since these ten seats are no longer available to satisfy the market group. In this manner, a market group record must be updated for each request directed to the market group, as well as for each request directed to a specific flight and seat that is included within the market group.

A market group record may also store other miscellaneous data, including an identifier that identifies each booking that has been booked to the market group. A market group record may further eventually store information concerning the manner in which the market group is mapped to the flights included in the market group definition. For instance, after the market group mapping occurs, this market group record may be updated to indicate that all ten seats in the market group were allocated to flight “XYZ” departing on March 1 because that flight was significantly under-booked. Any other mapping may occur that is permitted by availability of seats within the flights of the market group and as determined by the mapping rules.

As may be appreciated, the flight-based inventory contained in flight storage 408 may be initialized entirely based on information pertaining to the flights that are provided by the airline, the capacity of these flights, and the known size of each compartment and booking class supported by the flights. This flight-based inventory information is then used by rules engine 402 to construct the market-based inventory within market group storage 409. That is, as each market group definition is created, rules engine 402 interprets each of the market group definitions stored within rules storage 400 to create a corresponding record within market group storage 409. The total number of seats allocated to the group is determined by this definition. For instance, the definition in the example above determined that a total of ten seats were allocated to the group. The price of the seats in the market group may also be determined by this definition and stored within the corresponding record, if desired. In another embodiment, the price for the seats within the market group is controlled by a different fares module (not shown in FIG. 4).

The values of additional fields within the market group record are determined by rules engine 402 according to data stored within the flight-based inventory. For instance, rules engine 402 uses the flight-based inventory to determine the seats and flights that are included within this group. As an example, for the market group definition exemplified above, the rules engine will determine that all seats in all seven flights are included in the market definition. This seat and flight information may be stored within the market group record, as discussed above. Alternatively, this information need not be stored within the market group definition, but could instead be determined each time a booking request for seats in one of these flights is received.

Rule engine will also determine, based on the flights and seats included within the group definition, the total eligible seat count for use by the group. The remaining fields discussed above that may be included within the market group record, such as the seats sold within the group and seats available in the group, can be initialized based on the foregoing information. For instance, originally the seats sold is set to “zero”, and the seats remaining to be sold are set the number of seats allocated to the market group.

The flight-based inventory stored within flight storage 408 and the market-based inventory storage stored within market group storage 409 are used together to process availability and booking requests as follows. As discussed above, when a potential customer seeks to determine which flights are available to satisfy a desired itinerary, that customer submits an availability request to routing module 218. Routing module generates a list of all potential routes (i.e., flight or flight combinations) that would, assuming they are available, meet the customer's needs based on departure time and location, and destination location. This list of potential flights is provided to space module 216 via interface 302 (FIG. 3).

When space module 216 receives the list of potential flights from routing module 218, the list is forwarded to availability logic 410 within inventory management logic 303. Availability logic utilizes the flight-based inventory stored within flight storage 408 to determine which of the flights in the list has enough seats available of the requested type to satisfy the number of seats requested. This determination must take into account the desired compartment and any other information provided with the request.

After the list of available flights has been compiled using the flight-based inventory, availability logic 410 provides this list to rules engine 402. Rules engine determines which of the seats/flights of the requested type that are considered available, if any, are included within a market group definition.

For each of the available seats/flights that are included within a market group, it is determined whether using those seats/flights to satisfy the request will violate a market group rule. The way in which this is accomplished will be based on whether the market group is a limit or reservation type of market group, as discussed above. For a limit-type market group, this is accomplished by determining whether satisfying the request will cause the total eligible seat count for the market group to be decremented below zero. For a reservation-type market group, this involves determining whether satisfying the request will cause the total eligible seat count to be decremented below the number of seats still available to be sold within the market group. If none of these market group rules are violated, the associated seats/flight may be returned as an option in the response to the availability request.

It may be noted that just because certain seats on a particular flight are disqualified as an option for inclusion in a response to an availability request, all seats on that flight are not necessarily disqualified. For example, it may be possible that the flight-based inventory indicates that a group of seats is available to fulfill the request. However, only some of these available seats are included within a market group. For instance, the flight-base inventory may indicate that a group of available seats exist in the Q and P booking classes of an aircraft to fulfill an availability request. Only the seats in the Q booking class are included in the market group. Even if these seats in the Q booking class are disqualified because their use would result in a market rule violation, the P-class seats are still available for fulfilling the request, and may be provided as an option in the response.

After each flight that maps to a market group is processed in the foregoing manner, availability logic 410 generates a response for the availability request that includes all flights that have not been eliminated from the original available flight list. Each of the remaining flights has space available to fulfill the request, and this space does not violate a market group rule.

In addition to the specific flights that are included in the response in the above-described manner, the response may also include market group options. For instance, it may be possible that the availability request is of a type that is eligible for processing against the market group as well as specific flights. This will be determined by reservation rules that govern access to the market groups. For instance, assume that the availability request is requesting a travel date that is more than two months away, as is required by a reservation rule associated with the market group. Therefore, rules engine 402 determines that the availability request is eligible for processing to this market group. In this case, it is determined whether the number of seats that are still available within the market group is adequate to fulfill the request, and whether the total eligible seat count is also adequate to fulfill the request. If both of these conditions exist, this market group option may be included within the response along with the list of available seats/flights. This option may specify the market group by indicating the market group definition, including the discount price. For instance, the option may indicate a booking can be created on any one of the flights from Minneapolis to Washington D.C. during March 1 through March 7, but the exact flight to which the booking will occur will not be known at the time of booking. This booking will occur at the specified market group price, which is generally a discount fare.

In one embodiment wherein space module 216 does not store fare information for the flights, this fare information is obtained from a different fare module (not shown in FIG. 4) for each of these flights and market groups included in the response. All of the fare information, along with the flight and market group list, is returned to the requester via interface 311.

The above description provides an overview of the manner in which availability requests are processed. Booking requests may be processed in a similar manner. Assume, for instance, the requester issues a booking request to purchase one or more seats on a flight, such as a flight returned in the list of available flights. This booking request is provided to booking module 212. Booking module will forward this request on interface 310 to space module 216 to determine whether the requested flight is still available.

Within space module 216, the booking request is provided to availability logic 410, which must again retrieve the appropriate flight-based inventory record for this flight from flight storage 408. If the requested number of seats is no longer available on the flight, the request cannot be satisfied, and a response to this effect is therefore returned via interface 310 to booking module, which forwards the response to the requester. If, however, adequate space is available on the requested flight, availability logic 410 causes rules engine 402 to determine whether this space maps to a market group. If so, rules engine 402 must determine whether fulfilling the request by booking the customers on the specified space within the requested flight will violate the market group rules. As discussed above, the way this is determined is based on whether the market group is of a limit or reservation type. If the market rules are violated, the request cannot be fulfilled, as is indicated to booking module 212 in the manner described above.

Assuming the request does not violate any market group rules, and further assuming adequate space exists on the requested flight as determined both by the flight-based inventory, and the total eligible seat count for any corresponding market group, availability logic 410 provides a response to this effect on line 310 to booking module 212 indicating that the seats may be sold and the booking created.

In one embodiment, as the booking is created, booking module provides the booking information on interface 310 to space module 216, thereby allowing space module 216 to update the flight-based inventory and the market-based inventory. The flight-based inventory is updated by locating the record for the flight to which the request is being booked. The count of available seats in the booking class associated with the request is then decremented by the number of seats purchased. Rules engine 402 then determines if these seats are included within a market group. If so, the total eligible seat count for that market group will be decremented by the number of seats purchased, since the seats that have been sold are no longer available to satisfy the market group.

The discussion in the above paragraphs relates to a booking request that is of a conventional nature since it specifies a flight on which seats are to be purchased. Assume next that the booking request did not specify a flight, but rather indicates a market group. The request is initially issued to booking module 212, which forwards it on line 310 to space module 216 to determine whether seats are still available to fulfill the request. In this case, availability logic 410 causes rules engine 402 to reference the appropriate record for the market group in the market-based inventory. It is then first determined based on reservation rules whether the request is of a type that may be booked to the market group. As discussed above, such reservation rules take into account information pertaining to the booking request, and to the customer making that request.

If a booking request is eligible for booking to a market group, it is next determined whether the number of seats still available to be purchased within the market group is adequate to fulfill the request. If so, it must also be determined whether the total eligible seat count is adequate to fulfill the request. If either of these determinations indicates that not enough seats are available to fulfill the request, a response must be returned to booking module 212 via interface 310 indicating that the booking request cannot be fulfilled. If enough seats are available based on both of these determinations, however, a request is returned indicating the request may be honored.

Booking module 212 will book the passengers to the market group and provide information pertaining to this booking to space module 216. Rules engine 402 will then cause inventory update logic 403 to decrement the number of seats available for sale within the market group record by the number of seats sold. Inventory update logic 403 will also decrement the total eligible seat count by the number of seats sold, since these seats are no longer available to satisfy the market group. Information pertaining to the booking such as passenger information may, but need not, be retained with the market group record. Booking module 212 will then return a response to the requester that the booking was complete to the market group and the requested seats are therefore guaranteed to the requester. However, no flight information will be returned since the booked seats have not yet been mapped to a flight, only to the market group.

At some time in the future (generally, some time prior to departure of the first flight that is included in the market group), rules engine and mapping logic 402 will map the seats of the market group to flights that are included in the definition of the market group. This mapping may occur based on mapping rules stored within rules storage 400. For instance, a rule may be defined indicating the mapping will occur approximately equally across the three flights having the largest number of available seats, assuming enough seats are available in these three flights to accommodate this mapping. Thus, consider the foregoing example wherein the market group includes ten seats on flights from Minneapolis to Washington D.C. during March 1-March 7. The three flights within this flight group that have the most empty seats of the type included in the market group definition will be selected to accommodate the market group seats. Thus, two of the selected flights will accommodate three seats, and the third flight will accommodate four of the market group seats.

In a preferred embodiment, mappings will take into account booking information. This information may be stored with the market group record, or obtained from booking data 224 via interface 322 during the mapping process. According to the booking information, if five people traveling together are booked to a market group, and if seat availability permits, the seats accommodating these five people will be mapped to the same flight or flight combination. This will occur even if mapping the seats in this manner violates one or more mapping rules. Thus, in a default mode of operation, the booking information will override the mapping rules. In one embodiment, rules engine includes a mode setting to change this default operation such that the mapping rules will have priority over the booking data.

The mapping can occur in any manner defined by one or more mapping rules that may be retained within rules storage 400. If desired, a mapping rule can be associated with one or more of the market group definitions, or one or more global mapping rules can be defined for use in mapping all of the market groups. In another embodiment, the mapping rules for a particular market group may be stored within the market group record itself. Alternatively, the mapping of market groups to flights may be performed manually by an authorized agent of the airline.

Optionally, the manner in which market groups are mapped to flights may be stored within the market group record. For example, the flight number, as well as the number of seats that were mapped to the flight, may be stored within the market group record for each flight to which the space of the market group was mapped. Alternatively, or additionally, this information may be recorded in the flight-based inventory and/or within booking data 224.

When a market group is mapped to flights, the records for these flights must be updated within the flight-based inventory. Specifically, inventory update logic 403 updates each record for an affected flight by decrementing the number of available seats within the appropriate booking class by the number of seats from the market group that was assigned to the flight. This ensures that these seats are no longer available to satisfy a different booking request.

Generally, after a market group has been mapped to flights, the market group will be considered closed, and will not be available to book additional requests.

In one embodiment, rules engine 402 interprets other types of rules besides market definitions and reservation rules. Such rules include notification rules that determine when automated notifications will be issued to authorized airline personnel or customers regarding market group activity. For instance, a notification rule may be defined to cause rules engine 402 to send an indication to notification logic 414 when inventory management logic 303 completes a market group mapping. In response, notification logic 414 automatically generates an email message to each of the customers that is booked to the market group. This message indicates the flight to which they are now assigned following completion of the mapping. This email message may provide a flight number as well as a departure date and time, for instance. In the alternative, notification logic 414 may generate automated phone, fax, pager, or other communication transmissions providing this type of information. Customer contact information (e.g., email addresses, phone numbers, etc.) for these transmissions may be obtained from customer profile data stored within ODBC 222 and retrieved via interface 322.

In addition to, or instead of, the types of customer communications discussed above, notification rules may indicate that communications are to be provided to authorized airline personnel, such as those located at remote stations 104. Such communications may include those listed above, as well as the sending of one or more documents to specified printer devices, or the saving of electronic documents to one or more designated locations within a directory structure of system 100. Such documents may thereby be accessible to authorized personnel at one or more remote stations 104. The airline personnel may then review information related to the market groups, including any mapping information.

Automated notifications may involve the creation by report generation logic 416 of one or more pre-defined reports, the contents of which are determined by a respective report definition. Report definitions, like the other rules, may be retrieved from business rules 230 and retained within rules storage 400, or may instead be retained permanently by report generation logic 416. A report may include data that is retrieved directly from database systems 204, or that has been cached within one of the local storage areas such as market group storage 409. For instance, a report may include information on how a particular market group was mapped to flights, as may be useful for analyzing demand on the various flights that were included in the market group. Additional date included within a report may comprise information retrieved from booking data 224, space data 228, data associated with the booking request, customer profile data, and/or any other data retained within database systems 204 for use by RDCS 102. A report may further include values derived from the data retrieved from database systems and/or market group storage 409, as determined by the report definitions.

Before continuing with a more detailed discussion concerning the market group, reservation, mapping, and notification rules, it may be noted that many other embodiments of the logic of FIG. 4 are possible within the scope of the current invention. For instance, the flight storage 408, market group storage 409, and rules storage 400 may be replaced by a single general-purpose buffer. Moreover, if all rules and data are to be processed immediately upon retrieval from database systems 204, there may be no need to cache the rules and data for any length of time. In such an embodiment, these storage facilities may be replaced by smaller temporary buffers or eliminated entirely.

In one alternative embodiment, rules engine 402 and rules storage 400 may be replaced by tables. For instance, a table may be defined to include all of the attributes that may be used to define a type of space within a flight (e.g., departure and destination locations, flight numbers, departure times and dates, compartments, booking classes, etc.) The table includes an entry for each potential combination of these attributes. Each entry includes the “rules” for the respective attribute combination. For instance, the entry may store data describing if, and how, market groups will be handled for that attribute combination. The logic (e.g., the software) consults the appropriate table entry to determine how processing should proceed. This type of table-driven approach has the advantage of not requiring the use of a specialized rules engine. However, it does not provide the flexibility to allow new attributes and logic to be added dynamically, as is afforded by a rules engine.

In one embodiment, one or more of the logic sections shown in FIG. 4 may be incorporated into different modules instead of space module 216, or may instead be implemented as independent modules. For instance, the functionality implemented by notification logic 414 may be incorporated into the general-purpose dedicated notification module 217 (FIG. 2) of the type described in the commonly-assigned co-pending application entitled “Rules-Driven Status and Notification System for a Transportation Carrier” referenced above. Similarly, a general-purpose rules engine may be provided as an independent module to execute a more extensive set of rules that is not limited to the rule set described herein. An independent report generation module may likewise be provided in place of report generation logic 416 to generate a broader range of reports than those related to the market-based inventory. Thus, the system of FIG. 4 is to be considered as exemplary only, and not limiting

Next, a more detailed discussion of the types of rules related to market groups is provided. As discussed above, programmable rules may be defined that take into account any of the information maintained within space data 228 that is descriptive of the flights provided by the airline. Such information will generally include flight times, origins, and destinations. These rules may further specify flight compartments, booking classes, aircraft types, and/or where/when the booking or availability requests originated (e.g., a web site, a travel agency, a geographic location, etc.). Other data that may be referenced by some the rules, including reservation rules, includes customer profile data. Such information may even include a list of flights that are to be treated as the market group for booking purposes. Boolean logic operators (e.g., AND, OR, NOT) may be incorporated into the rules so that multiple factors may be considered.

The following English-language representation exemplifies a programmable business rule that defines a market group according to the current invention:

```
Select (Market_group1):
  Origin = Minneapolis AND
  Destination = Washington D.C. AND
  Depart_date = March 1 - 7, 2006 AND
  Compartment = (Coach OR Business_class)
```

This rule defines a market group designated as “Market_group1” that includes all seats in either the coach or business class compartments on all flights from Minneapolis to Washington D.C. departing Mar. 1 through 7, 2006. This market group could be further limited by specifying one or more booking classes as follows:

```
Select (Market_group2):
  Origin = Minneapolis AND
  Destination = Washington D.C. AND
  Depart_date = March 1 - 7, 2006 AND
  ((Compartment = Coach AND Booking_class = P) OR
  Compartment = Business_class)
```

This rule is similar to the foregoing, except the market group “Market_group2” is now limited to include only seats in the “P” booking class of the coach compartment or all seats in any booking class in the business compartment. Such rules may further incorporate departure times. For example:

```
Select (Market_group3):
  Origin = Minneapolis AND
  Destination = Washington D.C. AND
  Depart_date = March 1 - 7, 2006 AND
  Depart_time = 12:00am - 11:59 am
```

This rule is similar to the first rule set forth above, but only includes those flights departing during the morning hours.

Yet another type of rule may include or exclude certain flights. For instance:

```
Select (Market_group4):
  Origin = Minneapolis AND
  Destination = Washington D.C. AND
  Depart_date = March 1 - 7, 2006 AND
  NOT (Flight = ABC OR DEF OR GHI)
```

This rule defines Market_group4 to include all seats on all flights from Minneapolis to Washington D.C. during Mar. 1-7, 2006 except flights ABC, DEF, and GHI. The type of exclusionary clause appearing in the last line of this rule may be desirable if certain flights are known to be in high demand, and it is therefore highly unlikely that any of the market group seats would be mapped to these flights.

In a similar manner, market groups may be defined as a pool of specified flights as follows:

```
Select (Market_group5):
  (Flight = ABC OR DEF OR GHI) AND
  Booking_class = Q
```

This market group includes all seats in booking class Q on flights ABC or DEF or GHI. These flights may all be provided by the same airlines, or, in an alternative embodiment, may be flights provided by multiple airlines that have entered into a partnership agreement, for instance.

In another example, the market group may have multiple origin and/or destination locations, as follows:

```
Select (Market_group6):
  Origin = (Minneapolis OR Milwaukee) AND
  Destination = (IAD AND DCA)
  Depart_date = March 1 - 7, 2006 AND
  Depart_time = 12:00am - 11:59 am
```

This rule exemplifies how multiple departure and/or destination points may be included within a rule. This rule further indicates how the origins can be specified by geographic location (e.g. city, state, country, continent, etc.) or by airport code, as is the case when specifying the destination in the foregoing rule.

In still another example, the types of aircraft or services provided on flights may be specified. For instance, it may be desirable to create a market group for all flights that are serviced by a particular type of equipment, as follows:

```
Select (Market_group7):
  Origin = Minneapolis AND
  Destination = Washington D.C. AND
  Aircraft = DC10 AND
  Depart_date = March 1 - 7, 2006 AND
  Booking_class = Q
```

This rule selects all seats in booking class Q on all flights from Minneapolis to Washington D.C. on DC10 aircraft between Mar. 1-7, 2006. A similar rule could be defined to select seats on all aircraft that do, or do not, provide a certain service. For example:

```
Select (Market_group8):
  Origin = Minneapolis AND
  Destination = Washington D.C. AND
  Depart_date = March 1 - 7, 2006 AND
  Service = NOT meals
```

The above rule includes all seats on all flights from Minneapolis to Washington D.C. that do not include meals between Mar. 1-7, 2006.

The above-described rules pre-suppose that fields such as “Flight”, “Booking_class”, “Origin”, Destination”, “Depart_date”, “Aircraft”, “Service”, and so on, have been defined and are maintained within space data 228 or some other data stored within database systems 204. It further pre-supposes that the values specified for these fields within the rules (e.g., “meals” within the “Service” field) are pre-defined, valid values. Finally, as discussed above, the above examples assume that a pre-defined rules language similar to a programming or query language has been defined to express these rules. The syntax used to express such rules will be discussed in more detail below, but is largely arbitrary. The exemplary language provided herein is merely for illustrative purposes, and any other syntax compatible with a selected rules engine may be employed.

A market group is generally associated with a predetermined price, which is usually a discount price. This price can be associated with the market group using pricing rules as follows:
Price (Market_group8)=Market_group8_price

This rule sets all seats in Market_group8 to the price that is associated with variable “Market_group8_price”. This price may be set by an authorized inventory or pricing agent of the airline, or via an automated pricing system. This price is returned to the user with other information for the market group if the market group is included in a response to an availability request.

A market group is also allocated a predetermined number of seats, which can be accomplished as follows:
Allocate (Market_group8)=Marker_group8_seats

This rule allocates the predetermined number of seats indicated by the predefined constant or variable “Market_group8_seats” to the market group. The allocated number of seats may be selected by an authorized inventory agent of the airline, for instance.

As discussed above, some of the rules related to market groups may reference customer profile and/or data associated with the booking or availability request. These types of “reservation” rules control access to market groups. As an example, assume that booking data records information describing the booking request, such as where the request originated. Such information may include the name or identifier of a particular web site (e.g., Orbitz.com), the name of a travel agency or a Global Distribution System (GDS), the name of a booking agent employed by the airline, and/or a geographic location. Additional information may indicate the date and/or time at which the booking request was issued. This type of “Point of Sale” (POS) information may be used by reservation rules that limit access to the market groups. As an example, consider the following rule:
Reserve All of Market_group5 for (POS=Orbitz OR Expedia)

This reservation rule reserves all of the seats allocated to Market_group5 for booking requests having a POS as being either the Orbitz.com or Expedia.com websites. When a booking request is received that may potentially be booked to this market group, rules engine will only provide an indication to booking module 212 that the booking may be completed if the information describing the booking request has one of the designated POSes, as required by this reservation rule. In one embodiment, this type of additional requirement on the sale of seats allocated to the market group may be recorded within an additional field provided within the market group record.

It may be noted that reservation rules of the type exemplified above will generally only be employed with reservation-type market groups. This is because with limit-type market groups, there is no guarantee that any seats will ever be sold to the market group. That is, the number of seats allocated to the market group only serves as a maximum limit, and does not actually reserve seats for the market group. Therefore, nothing further will be accomplished by reserving portions of the allocated seats for certain customers or request types.

Other types of reservation rules may be defined. For instance, some rules may take into account the time and/or date at which the request was issued, as follows:

Reserve 5 of Market_group5 for (Request_date=January 1 -
January 31)

This rule reserves five of the seats in the market group 5 for those booking requests that are issued between the specified dates of January 1-31. If this type of reservation rule is utilized, additional fields must be added to the market group record to track how many of the total seats allocated for the market group have thus far been sold in the reservation category. This information must be considered when determining whether a particular booking request may be booked to the market group. For instance, if the request does not meet the reservation criteria and all remaining seats allocated to the market group must be reserved as dictated by the reservation rule, the booking request cannot be honored by a booking it to the market group.

The above reservation rules provide examples of using request information to reserve seats within market groups. Other types of booking data and/or customer profile data may be used instead of, or in addition to, this request information. For example, consider the following rule:

Reserve 10 of Market_group5 for (Customer_status = (Frequent_flier
OR Previous_disservice))

This rule reserves 10 of the seats allocated to market group 5 for those customers that are frequent fliers of the airline, or that have a recorded history of previously experiencing some type of service problem with the airline, such as being “bumped” from a flight. This rule pre-supposes that fields such as “Customer_status” have been defined for data stored within database systems 204, and that values such as “Previous_disservice” are valid values for use in this field. This type of customer status data may be maintained with the customer's profile information, as may be stored within OCDB 222.

Other types of booking data may be used to define reservation rules, including how many seats are associated with the booking request, whether the booking request is associated with any special requests (e.g., a request for a wheelchair), and so on. For instance, a reservation rule may be defined to allow only those requests that are associated with four or fewer travelers from gaining access to space allocated to a market group. Any type of data maintained within database systems 204 may be used to create a reservation rule.

Reservation rules may be used to shape an airline's sales model. For instance, assume an airline is targeting family business. This airline may define a reservation rule to reserve seats in a market group for those adults that are traveling with children. Another airline may instead target business travelers and may therefore create reservation rules to reserve seats for those travelers that are booked using a corporate travel account. In yet another example, an airline may have a particularly high-profile client “Business_X”. Assume that an attribute is defined and maintained (e.g., within OCDB 222) that reflects when a booking is associated with an employee or client of Business_X. This attribute may be used to create reservation rules to reserve seats for such travelers in a particular market group.

As discussed above, in one embodiment, mapping rules may be defined to control the manner in which the market groups are mapped to flights. For example, the following mapping rule may be defined:
Map Market_group5 Equally

This rule, which pre-supposes an action of “Equally” has been pre-defined, will be interpreted to map seats as equally as possible across all flights in the market group. As noted above, in a preferred embodiment, this mapping rule will be overridden by booking information so that all passengers on the same booking will be assigned to the same aircraft whenever possible.

Another mapping rule may be as follows:
Map Market_group5 Most_available 2 This rule maps the seats of Market_group5 to the two flights in the market definition that have the greatest number of seats available. Many other types of mapping rules may be defined in a similar manner.

Notification rules may likewise be defined to initiate automated notification actions when certain events associated with market groups occur. For instance, when a market group is mapped to flights, a notification may be automatically generated to the passengers that are affected by this mapping to inform these customers of the results of the mapping. Such a notification may involve an email message that includes the flight and seat information resulting from the mapping.

Other types of automatic notifications that may be issued include the generation of an automated message or fax transmission, the issuance of a page, the saving of an electronic document at a predetermined location in a directory structure accessible to an authorized airline agent, the transmission of a document to a predetermined print device, generation of an instant message, and so on. Any of these types of notifications may be defined by a notification rule, which is one of the types of rules retained within rules storage 400.

Several exemplary notification rules are as follows:
Notify1: email message1 address_list1
Notify1 if Market_group5 Mapped

The first rule defines a notification action designated as “Notify1”. This notification action will result in notification logic 414 sending an email message containing the text associated with “message1” to all of the personnel associated with the address list “address_list1”. This rule pre-supposes that the message and address list associated with “message1” and “address_list1”, respectively, have been defined. The message “message1” may be defined to incorporate data retrieved from database systems 204 or from local storage such as flight-based inventory 408 by rules engine. Thus, “message1” may include the flight assignments resulting from the mapping activity, for instance.

The second rule is a trigger event rule that indicates that the notification action associated with the character string “Notify1” will be initiated when Market_group5 is mapped to flights. In the alternative, a notification could be triggered to send selected airline personnel an email message each time a booking occurs to a market group, when a market group is created, or based on any other event associated with the market group.

The current invention further allows an airline or other carrier to selectively enable and/or disable the use of one or more market group definitions. For instance, an enabling rule may be defined as follows:
Enable Market_group1 if (Date>Jan. 1, 2006)

This rule enables the use of market group “Market_group1” after Jan. 1, 2006. Before this time, no booking requests can be booked to this market group.

In a similar manner, a disabling rule may indicate that one or more rules are to be taken out of use. For example, a disabling rule may disable use of the rule for “Market_group1” after a particular time and date. After this time, this rule will no longer result in bookings to the market group, and this market group may then be mapped to flights.

As discussed above, the syntax used to illustrate the foregoing market group, reservation, mapping, and notification rules is merely intended for discussion purposes and to exemplify concepts. It will be understood that this syntax is largely arbitrary and many other types of syntax may be used to express these concepts. Moreover, while the foregoing examples utilize a pseudo English language format for ease of reference, it will be appreciated that when these rules are stored as business rules 230, they are expressed in a digital format (e.g., as a series of ones and zeros) that may be interpreted by the software, firmware, microcode, and/or hardware used to implement limits logic 303, and specifically, rules engine 402.

A user may define the market rules, mapping rules, and/or notification rules using a pseudo language such as that described above, which is similar to a programming or query language. Alternatively, these rules may be defined using the help of a Graphical User Interface (GUI) that is provided as one of user interface modules 234 (FIG. 2) executing on remote stations 104 and/or user interface modules 201 on web servers 200. If this type of interface is used, the user need not become familiar with any type of rules language, since the GUI interface will format the rules as the GUI operators (e.g., drop-down menus, radios, buttons, etc.) are selected. An exemplary GUI interface will be discussed further below.

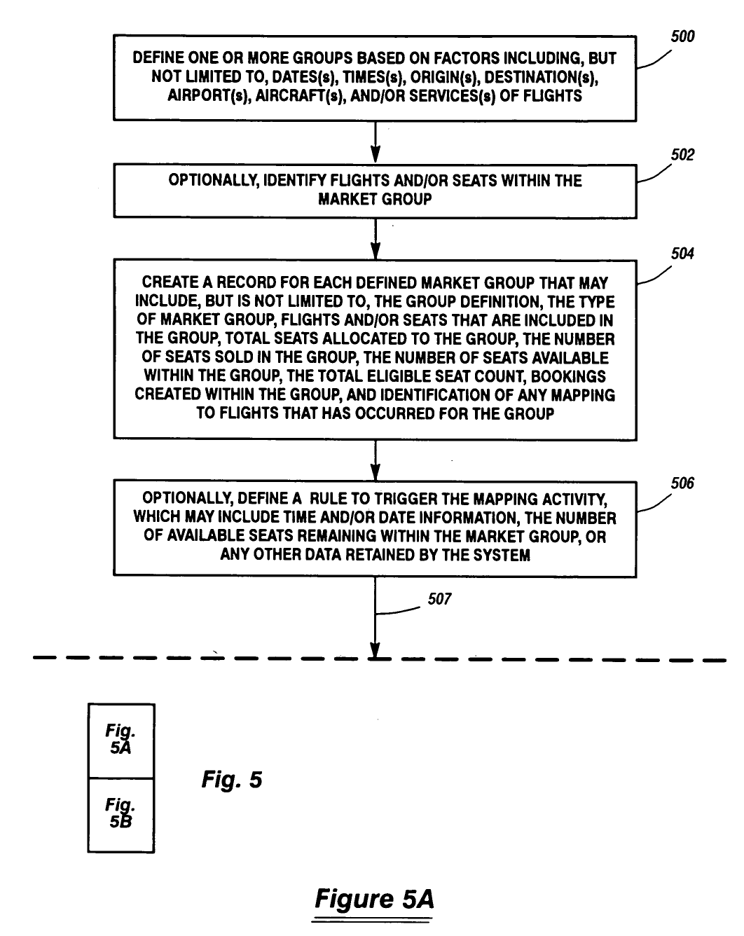

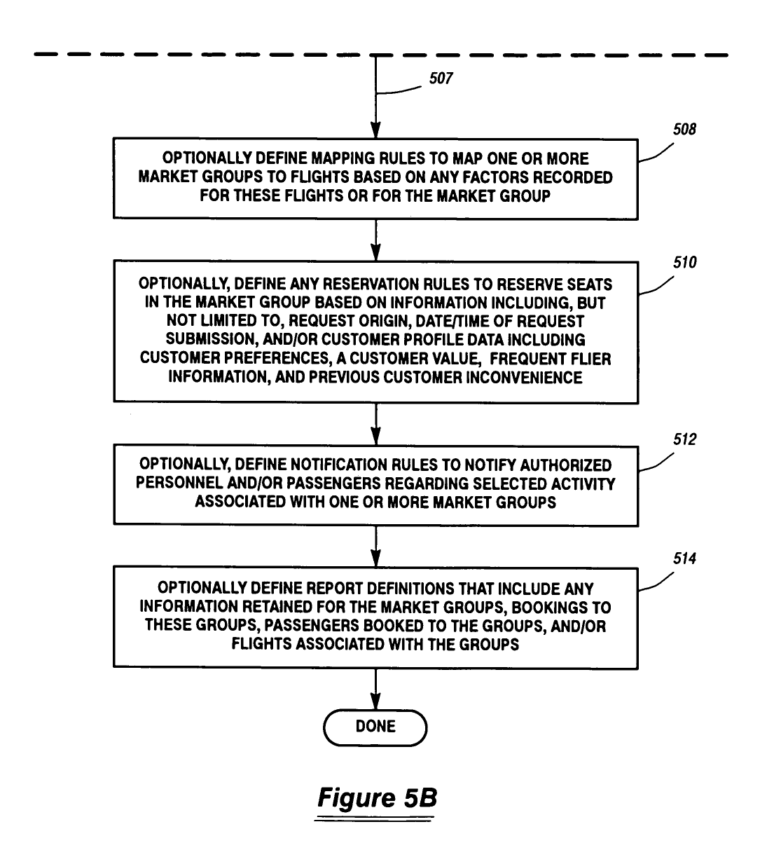

FIG. 5A and 5B, when arranged as shown in FIG. 5, are a flow diagram of an exemplary method of defining a market group according to the invention. First, one or more market groups are defined based on factors that include, but are not limited to, date(s), time(s), origin(s), destinations(s), airport(s), and/or services for the flights (500). If desired, the flights and/or seats that are included with this market group may be identified at the time of market group creation so that this data may be recorded with the other market group information (502). Alternatively, these flights may be determined later as availability and booking requests are received and processed.

A record may then be created for each defined market group (504). This record may store information that includes, but is not limited to, the group definition, the type of market group (e.g., limit or reservation type), flights and/or seats that are included within the market group, a total number of seats allocated to the group, the number of seats sold in the group, the number of seats available within the group, the total eligible seat count, an identification of the bookings created within the group, any reservation restriction associated with the market group, and/or any flight-to-market mappings that have occurred thus far.

If desired, a rule may be defined to trigger mapping activity for the market group (506). This rule may include time and/or date information (e.g., map two days prior to departure of the earliest departing flight in the market group.) This rule may also, or instead, specify the number of available seats remaining within the market group (e.g., map the group when all seats in the market group are sold). Any other data describing the market group or the flights in the market group may be used to trigger the mapping.

Processing next continues to FIG. 5B, as indicated by arrow 507. In step 508 of FIG. 5B, mapping rules may optionally be defined to map one or more market groups to flights. This mapping may occur based on any of the factors recorded for the flights or for the market groups. For example, a market group may be mapped to the two flights having the most available seats, and so on.

If desired, a mapping rule may be defined only for mapping one or more market groups with which it is associated. Alternatively, a single set of global mapping rules may be defined that will be used to control mapping of all market groups.

Reservation rules may likewise be defined (510). Such rules may be defined to reserve seats in a market group based on information including, but not limited to, request origin, date/time of request submission, and/or customer profile data (e.g., customer preferences, customer value to the airlines, frequent filer information, previous customer inconvenience, etc.)

Other types of rules that may be defined include notification rules (512). These rules are used to notify authorized personnel and/or passengers regarding selected activity associated with one or more market groups. The rules may further include report definitions (514). These rules define the types of reports that may automatically be generated and issued to authorized personnel based on market group activity. Such reports may include any of the information retained for the market groups and/or flights included in the market group definitions, such as the bookings made to a market group, how the mapping occurred for the group, and so on.

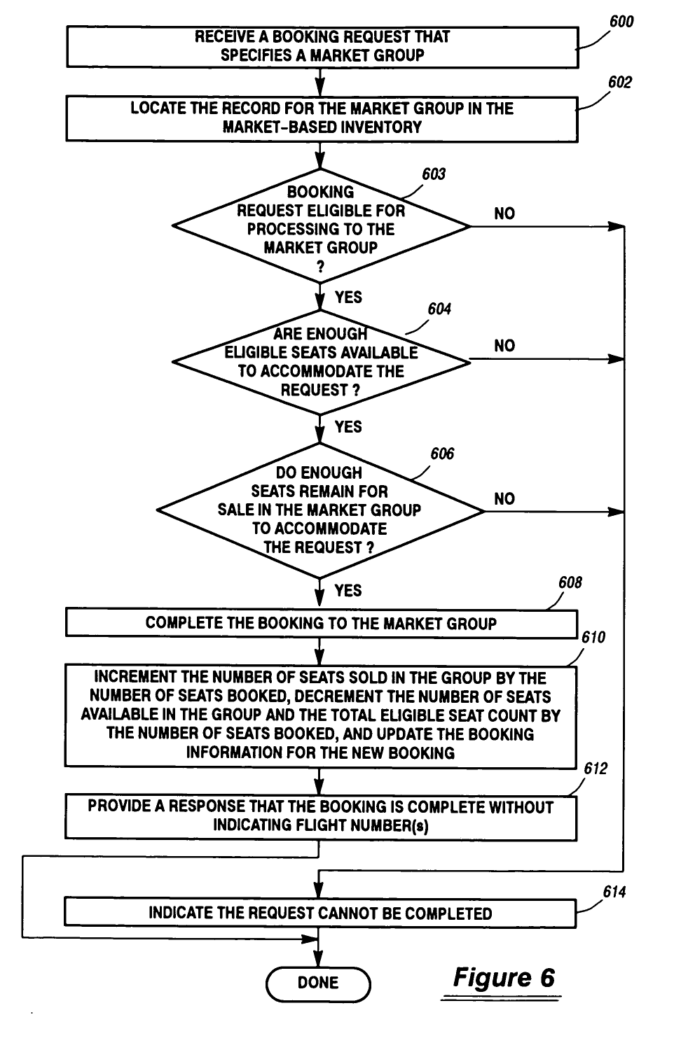

FIG. 6 is a flow diagram of one method of handling a booking request that specifies a market group according to the current invention. First, the request is received (600). Next, the record for the market group is located within the market-based inventory (602). It may then be determined whether the particular booking request is eligible for processing to the market group (603). This determination may depend upon optional reservation rules defined to control the types of requests and/or customers that may be booked to the market group. Such rules may take into account information such as the origin, time, and/or date of the request, and/or customer profile information. Such reservation rules may be stored within the corresponding market group record, or elsewhere within the system.

If the request is not eligible for processing to the market group, processing continues to step 614, wherein a response is returned indicating the request cannot be completed. However, if in step 603 the request is eligible for processing to the market group, execution continues to step 604 where it is determined from information in the market group record whether enough total eligible seats are available to satisfy the request (604). In one embodiment, this is accomplished using the number of available seats specified by the total eligible seat count for the market group.

If a sufficient number of eligible seats are available to satisfy the request, it is determined whether enough seats remain for sale within the market group to accommodate the request (606). In one embodiment, this is determined by the count of seats available within the market group. If a sufficient number of eligible seats are available to satisfy the request, the booking may be completed to the market group (608). The record for the market group may then be updated to reflect this booking (610). In one embodiment, this involves incrementing the number of seats sold in the group by the number of seats booked. In addition, the number of seats available in the group, as well as the total eligible seat count, may be decremented by the number of seats booked. Finally, the updated booking information for the new booking may be stored to the market group record. This may include customer names, addresses, contact information and/or other information associated with the booking. A response may then be returned indicating the booking request has been completed (612). This response will not include a flight number, since the booking has not yet been mapped to a flight.

Returning to step 604, if not enough seats are available to accommodate the request, as indicated by the total eligible seat count for the market group, processing proceeds to step 614 where a response is provided indicating the booking request could not be completed to the market group. Likewise, in step 606, if not enough seats remain for sale in the market group, as indicated by the count of seats available, processing continues with step 614 where a similar response is provided indicating the request cannot be completed.

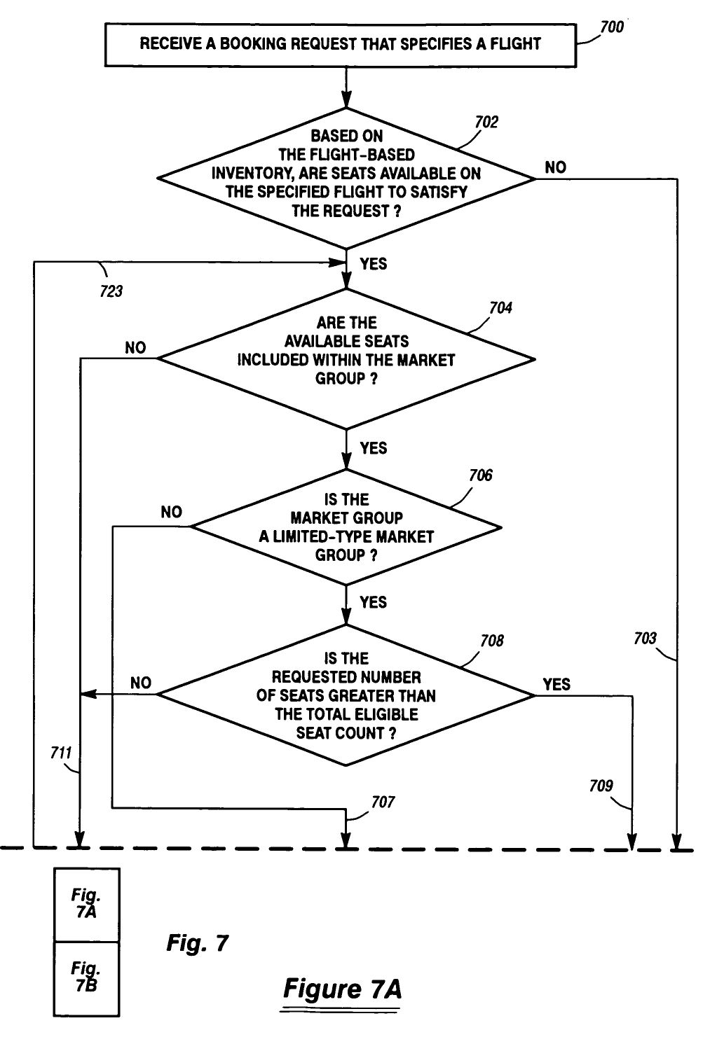

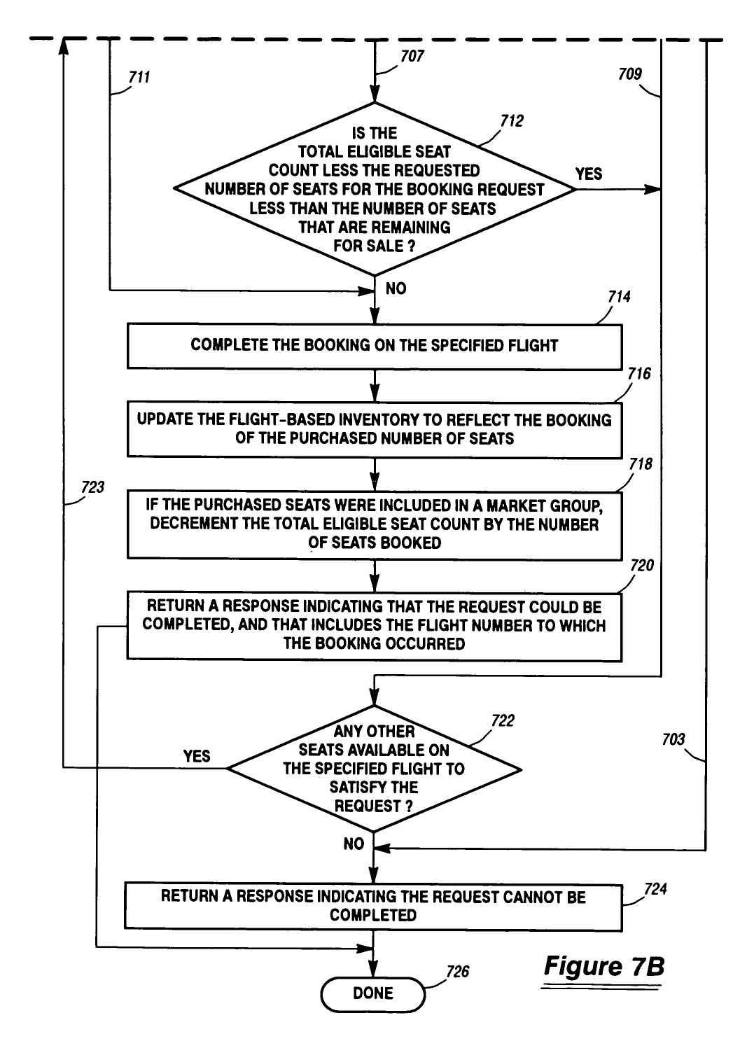

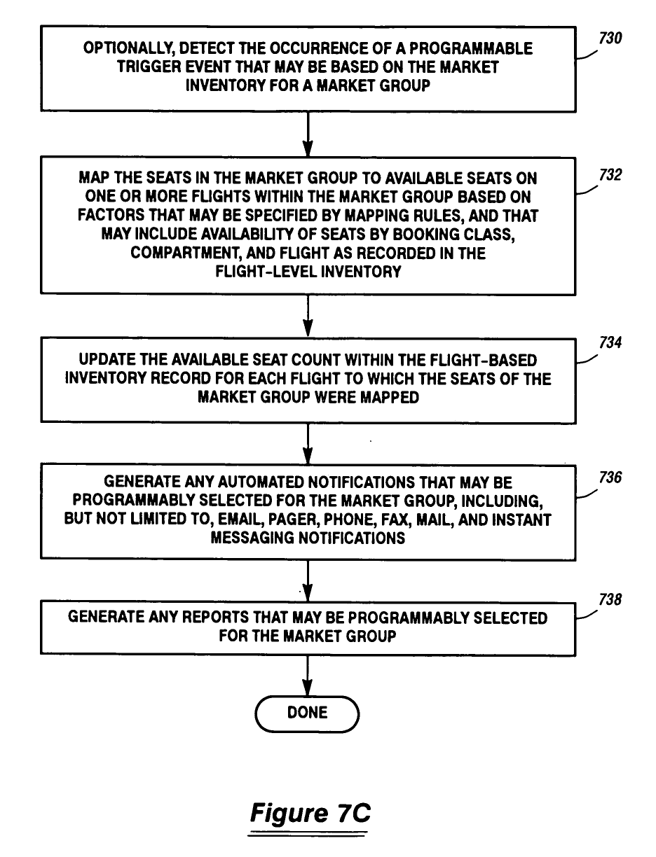

FIGS. 7A and 7B, when arranged as shown in FIG. 7, are a flow diagram illustrating one method of processing a booking request that specifies a flight number according to the current invention. After the booking request is received (700), a flight-based inventory is consulted to determine whether seats are available on the specified flight to satisfy the request (702). If not, processing continues with step 724 of FIG. 7B, as indicating by arrow 703. In step 724, a response is returned indicating the request cannot be completed.

Returning to step 702 of FIG. 7A, if seats are available on the requested flight as indicated by the flight-based inventory, it is determined whether the available seats are included within the market group (704). If the seats are not included within the market group, processing continues to step 714 of FIG. 7B, wherein the booking is completed on the specified flight. The flight-based inventory is updated to reflect that the purchased number of seats of the requested type are no longer available on the flight (716). In step 718, if the purchased seats were included within a market group, the total eligible seat count is decremented by the count of seats booked (that is, purchased). In the current scenario, the seats were not included within a market group, so this step is not performed. A response may then be returned indicating that the request could be completed (720). This response includes the flight number to which the booking occurred. Processing is then considered complete (726).

Returning to step 704, if the available seats are included within a market group, it is determined whether the market group is of a limit-type (706). If so, processing continues with step 708, where it is determined whether the requested number of seats is greater than the total eligible seat count for the market group. If so, the request cannot be fulfilled, since booking the requested number of seats will cause seats that have been booked to the market group to become double-booked. Therefore, processing continues to step 722 of FIG. 7B, as indicated by arrow 709.

In step 722, it is determined whether any other seats are available on the requested flight to satisfy the booking request, as determined by referencing the flight-based inventory. For instance, assume that seats in more than one booking class are available and eligible to fulfill the request based on the flight-based inventory. However, seats in only one of these booking classes are included within the market group. In this case, the process should be repeated to determine whether the other seats could be used to fulfill the current request. In this case, processing returns to step 704 of FIG. 7A as indicated by arrow 723. There, processing is repeated for these other seats. If, however, no other available seats exist on the flight to fulfill the request, a response is returned indicating the request cannot be completed (724).

Returning to step 708, if the requested number of seats is not greater than the total eligible seat count, processing continues to FIG. 7B, as indicated by arrow 711. In step 714, the booking may be completed to the specified flight. The flight-based inventory is updated to reflect the booking of the purchased number of seats (716). Since these purchases seats were included in a market group in this instance, the total eligible seat count for the market group must be updated. This involves decrementing the total eligible seat count by the number of seats booked to reflect that these seats are no longer available to fulfill any other request, including one directed to the market group (718). A response is then returned indicating that the request was booked (720). This response will include the flight number for the flight to which the booking occurred. Processing is then considered complete (726).

In still another scenario, it may be determined that the market group is of the reservation type in step 706 of FIG. 7A. In this case, processing continues to FIG. 7B, as indicated by arrow 707. There, the requested number of seats is subtracted from the total eligible seat count. If the result is less than the seats that remain for sale in the market group, the request cannot be fulfilled. This is because fulfilling the request will result in an inability to fill all remaining seats that are reserved for the reservation-type market group. Therefore, processing continues to step 722 where it is determined whether any other seats are available on the specified flight based on the flight-based inventory. If so, processing continues to step 704 of FIG. 7A. There, these other seats are checked for availability based on the market-group inventory in the manner described above. Otherwise, a response is returned indicating the request cannot be fulfilled (724). Processing is then considered complete (726).

Returning to step 712, if, when the requested number of seats is subtracted from the total eligible seat count, the result is not less than the seats that remain for sale in the market group, the request can be fulfilled. In this case, the booking may be completed to the specified flight (714). The flight-based inventory is updated to reflect the booking of the purchased number of seats (716). Since these purchases seats were included in a market group, the total eligible seat count for the market group must be decremented by the number of seats booked to reflect that these seats are not longer available to fulfill any other request, including one directed to the market group (718). A response is then returned indicating that the request was booked (720). This response will include the flight number of the flight to which the booking occurred. Processing is then considered complete (726).

It may be noted that if a booking request involves booking several flights, the process of FIG. 7 must be repeated for each flight.

FIG. 7C is a flow diagram of one method of mapping a market group to flights according to the current invention. In one embodiment, some type of pre-determined trigger event occurs that prompts the mapping (730). For example, a programmable rule may be defined that prompts the mapping of a market group a week prior to the departure date of the first flight included in the market group definition. Alternatively, for each market group, a specific date may be selected to automatically initiate the mapping process. In yet another embodiment, this process may be initiated manually by authorized personnel of the airline.

Regardless of how the mapping is initiated, it is accomplished by mapping the seats sold in the market group to available seats on one or more flights within the market group. This mapping occurs based on factors that may be specified by programmable mapping rules, and may include availability of seats by booking class, compartment, and flight as recorded in the flight-based inventory (732). The flight-based inventory record must be updated for each flight to which the market group seats are mapped (734). For instance, the available seat count must be decremented for the appropriate seats to reflect that some seats are now no longer considered available.

Automated notifications may be generated based on notification rules (736). Such notifications may include email, pager, phone, fax, and/or mail transmissions that are automatically generated based on the rules. For example, these transmissions may inform passengers about the mapping that occurred, and may include flight and seat information.

Optionally, reports may be generated automatically based on programmable report definitions (738). These reports may include any selected information associated with the market group and/or mapping activity.

It may be noted that the flow diagrams of FIGS. 5-7C are exemplary only, and many other embodiments are available for these methods. For example, in many cases, the steps may be re-ordered, and many steps are merely optional and may be deleted entirely. Thus, they are to be considered illustrative, and not restrictive.

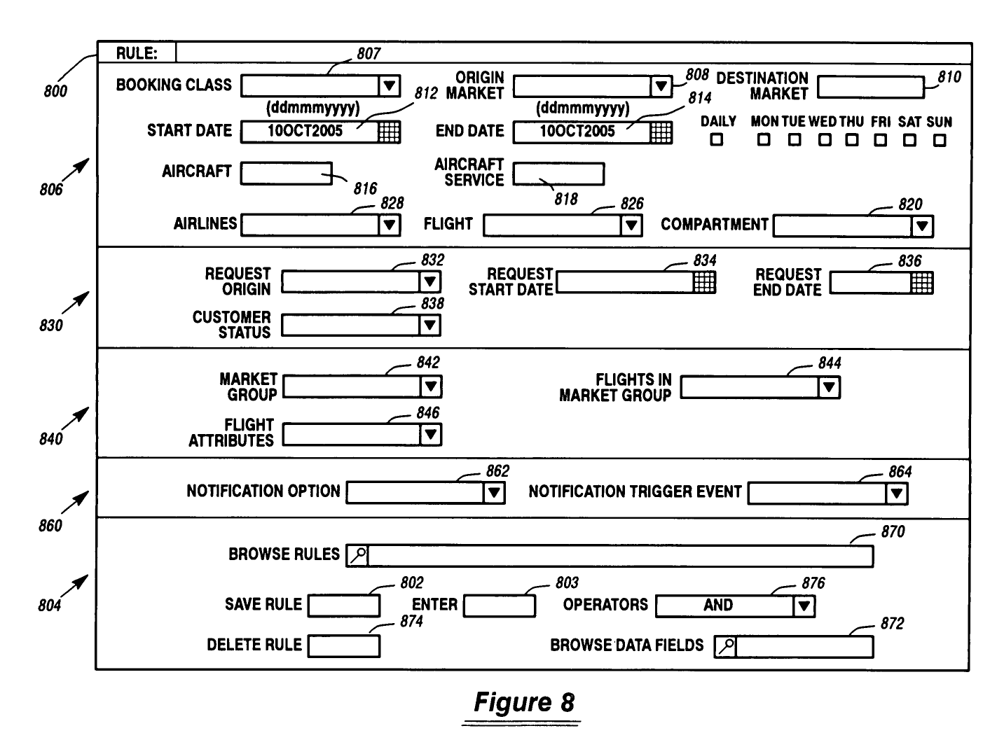

FIG. 8 is a block diagram of a Graphical User Interface (GUI) that may be used to define the types of rules described above. FIG. 8 is a screen diagram illustrating an exemplary screen such as may be used to define programmable market group, reservation, notification, and mapping rules. A window 800 is used to display a rule that is under definition by an authorized user. When the definition has been completed, it may be saved, if desired, by selecting the “Save Rule” button 802 of screen area 804.

Rules such as those exemplified above are defined by making selections using drop-down menus and other GUI utilities such as radios, buttons, browse functions, and so on. Data such as market group names, and other labels and numbers may be entered using the keyboard or some other input device.

In the exemplary GUI interface of FIG. 8, screen area 806 provides various GUI functions for use in defining market group definitions. Using the drop-down menus in screen area 806, market groups can be defined based on information stored within space data, such as the booking class, flight origin, and flight destination for the market (e.g., all Q-class seats on all flights between New York and Hong Kong). This type of information is selected using drop-down menus 807, 808 and 810, respectively. It may be noted that the origin and destination markets may be specified using cities, states, countries, continents and/or airport codes, or any other origin and destination designations. The types of selections available when using the drop-down menus may be selected by authorized personnel of the airline.

Also available for defining the market groups are start and end dates that define date ranges for the market groups. This information is selected using windows 812 and 814, respectively. If desired, specific days of the week may be selected to limit these date ranges, as shown by the days-of-the-week checkboxes. Thus, for instance, a market group may be defined that includes only those flights departing on one of the selected days of the week within the specified date range. Other information that may be selected for use in the market group definition includes types of aircraft and aircraft services, as shown in regards to drop-down menus 816 and 818, respectively. Specific flights may be selected for inclusion in a market group using drop-down menu 826. Such flights may be on one or more airlines, as selected using menu 828. Compartments may be selected using menu 820.

The choices of screen area 806 may be related using Boolean operators, as discussed above. These operators are chosen using drop-down menu 876 of screen area 804 followed by selection of the “Enter” button 803. Boolean operators may be selected when defining other types of rules using the other screen areas 830, 840, and 860.

Another screen area 830 is provided to define reservation rules. As indicated above, such rules may be used to control access to seats allocated to a market group. For instance, some or all of the seats allocated to a market group may be reserved for requests having desired request origins (e.g., certain GDSs, websites, geographic locations, etc.) This is selected using drop-down menu 832. Likewise, the dates and/or times on which requests are issued may be specified by the reservation rules. For example, menus 834 and 836 may be used to select date ranges. Only those requests received during the specified date range are eligible to be booked against the market group.

As noted above, customer profile information may also be used to define reservation rules, if desired. For instance, customer status menu 838 may be provided to select those customers that are eligible to be booked against the market group. The selections available with this menu may be defined to include “high-value” customers, “frequent flier” customers who are defined as those customers having over a certain number of frequent flier miles, “business” travels who book a predetermined number of seats per year for business purposes, or any other type of status that the airline defines and tracks for its customers.

Yet another screen area 840 is provided to allow for the definition of mapping rules. This type of area may include a menu 842 to select the name of the market group that is to be mapped. After this selection is made, drop-down menu 844 will provide a list of all flights that are included within this market group that still have seats available of the type indicated by the market group definition. One or more of these flights may be selected as part of the mapping rules. Alternatively, flight attributes (e.g., “most available seats”, etc.) may be selected using menu 846. This allows mapping to occur to the “X” number of flights having the “most available seats” of the type included in the market group. Character strings (e.g., numbers) may be entered via the keyboard to map market groups to any number of such flights of the type selected using drop-down menu 846.

Screen area 860 provides drop-down menu 862 to select notification options such as email, fax, pager, printer, and/or other automatically-generated communication transmissions for use when defining notification rules. Another drop-down menu 864 is provided to select a notification trigger event such as “Mapped”. These trigger events may be used to define a notification trigger rule that determines when a corresponding notification rule will be used to issue a communication. For instance, a trigger rule may be defined so that the corresponding notification is issued when the market group associated with the notification rule is mapped to airline seats. The market group may be selected using menu 842 of screen area 840. Alternative, another drop-down menu may be provided in screen area 860 for this purpose.

As discussed above, screen area 804 includes various general-purpose utilities such as the “Save rule” button 802 that is used to save the rule appearing in window 900 when a definition is considered complete. The “Browse rule” and “Browse data fields” functions associated with windows 870 and 872 allow a user to browse previously defined rules, and further to view the various data fields that have been defined for space data 228 and booking data 224. An authorized user may decide to delete a previously-defined rule highlighted in window 870 using the “Delete rule” button 874. Drop-down menu 876 allows a user to select Boolean operators (e.g., AND, OR, NOT) for inclusion in the rules, as mentioned above. When the “Enter” button 803 is selected, other menu selections highlighted in the other menu areas appear within window 800 for inclusion in a rule.

The exemplary GUI screen of FIG. 8 provides a very simple illustration of an interface that may be utilized to define market group, mapping, reservation, and notification rules according to one embodiment of the current invention. It will be appreciated that many alternative user interfaces may be provided, including an interface that supports rules definition using a rules-definition language such as that illustrated above. Moreover, FIG. 8 is not exhaustive. For instance, for ease of reference, this figure does not include a window for report definitions, or for defining the notification options such as the device and path names, email address lists, and so on, that are used to generate the notification. Other similar windows may be defined to support entry of these types of data.

The foregoing example illustrates the very flexible and powerful programmable mechanism that may be employed to define market groups, reservation rules, mapping and notification rules, and report definitions using booking, space, request, and/or customer profile data. Using this system, customers need not be booked to a flight in order to be guaranteed a seat. This system can be used to maximize the profits of an airline, or any other transportation carrier. As mentioned above, the mechanisms described herein are equally applicable to a bus or train line, a cruise line, or any other type of transportation provider. Similarly, other services industries may utilize the system and method to control the sale of services and maximize revenues. For instance, a hotel or resort chain may employ a similar system based on programmable rules or other programmed logic to control the sale of rooms based on request and customer information and space data. As another example, a service that specializes in the sale of seats for public events such as sporting engagements, concerts, or other similar activities may utilize the current system and method.

Therefore, the invention is susceptible to various modifications and alternative forms. Specific embodiments thereof have been shown by way of example in the drawings, although many other variations of the above-described systems and methods are possible. Thus, it should be understood that the detailed description is not intended to limit the invention to the particular forms disclosed. On the contrary, the intention is to cover all modifications, equivalents, and alternatives falling within the spirit and scope of the invention as defined by the appended claims.

1. An automated method of managing physical routes provided by a transportation carrier, comprising:
defining one or more market groups, each including a selected amount of space to be accommodated on any one or more of the physical routes selected for inclusion in the market group;
booking at least some of the space to one or more customers of the transportation carrier; and
after the booking step is completed, mapping the space that was booked to the one or more customers to any one or more of the physical routes selected for inclusion in the market group.

2. The method of claim 1, wherein the defining step includes maintaining a market-based inventory to describe each of the one or more market groups.

3. The method of claim 1, wherein the defining step includes defining one or more programmable business rules.

4. The method of claim 3, wherein the programmable business rules are selected from a group consisting of:
rules to define the market groups;
rules to reserve space within the market groups for selected customers of, or selected requests submitted to, the transportation carrier;
rules to trigger the mapping of the space;
rules to control the mapping of the space;
rules to enable use of one or more of the market groups;
rules to disable use of one or more of the market groups;
rules to define automated notification actions to be initiated in association with the market groups; and
rules to define reports to be generated in association with the market groups.

5. The method of claim 1, wherein the mapping step includes mapping the space that was booked to one or more of the selected physical routes based on programmable selections.

6. The method of claim 1, wherein each of the market groups is selected from a group consisting of:
a reservation-type market group to reserve the selected amount of space for the market group; and
a limit-type market group to limit space booked to the market group to no more than the selected amount of space.

7. The method of claim 1, and further including:
maintaining a route-based inventory to track space available on each of the physical routes;
using the route-based inventory to determine whether space requested on a selected one of the physical routes is available;
determining, based on information describing a market group including the requested space, whether the requested space is available; and
booking the requested space to the selected physical route only if the route-base inventory and the information describing the market group indicates the requested space is available on the physical route.

8. The method of claim 1, and further including:
maintaining a route-based inventory to track space available on each of the physical routes;
booking requested space on one of the physical routes;
updating data associated with the one of the physical routes in the route-based inventory to record that the requested space was booked; and
updating data that describes one of the market groups that includes the requested space, the updated data to record that the requested space is no longer available for use in booking any of the selected amount of space for the one of the market groups.

9. The method of claim 1, wherein the defining step includes defining programmable business rules that take into account data selected from a group consisting of:
departure locations for the physical routes;
destination locations for the physical routes;
departure times for the physical routes;
departure dates for the physical routes;
booking classes for the physical routes;
compartments for the physical routes;
services provided in association with the physical routes;
information describing customers of the transportation carrier;
information describing requests for services submitted to the transportation carrier;
information describing space available on the physical routes provided by the transportation carrier; and
information describing booking of services by the transportation carrier.

10-16. (not entered)

17. A data processing system for use by a transportation carrier, comprising:
means for defining market groups, each including selected space on selected routes provided by the transportation carrier; and
booking means for booking passengers on at least part of the selected space of one or more of the market groups without determining which of the selected routes the passengers will travel.

18. The system of claim 17, further including mapping means for mapping the at least part of the selected space to one or more of the selected routes.

19. The system of claim 18, further including storage means for storing programmable parameters to control mapping of the selected space to the one or more of the selected routes based on business objectives of the transportation carrier.

20. The system of claim 17, further including graphical user interface means for defining the market groups.

21. The system of claim 17, further including:
means for storing data describing availability of space on a route-by-route basis for one or more of the routes provided by the transportation carrier; and
wherein the booking means includes means for booking passengers for travel on requested routes only if the stored data indicates availability of space on the requested routes and the space on the requested routes has not been booked as the at least part of the selected space of one of the market groups.

22-24. (not entered)
